(19) United States
(12) Patent Application Publication
(10) Pub. No.: US 2017/0030109 A1
(43) Pub. Date: Feb. 2, 2017

(54) PORTABLE LOCKS AND LOCK SYSTEMS

(71) Applicant: 13876 YUKON INC., Whitehorse (CA)

(72) Inventors: Gordon Andrew DUNCAN, Whitehorse (CA); Alexander Jeffrey FELDMAN, Vancouver (CA); Alexander John STONE, Burnaby (CA)

(21) Appl. No.: 15/301,317

(22) PCT Filed: Apr. 3, 2014
(86) PCT No.: PCT/CA2014/050336

§ 371 Date: Sep. 30, 2016

Related U.S. Application Data
(63) Continuation-in-part of application No. 14/093,357, filed on Nov. 29, 2013.

(51) Int. Cl. E05B 47/00; E05B 73/00; E05B 67/22; E05B 17/20; E05B 67/10; E05B 67/14

(52) U.S. Cl. CPC E05B 47/0001; E05B 47/0012; E05B 47/0004; E05B 47/0009; E05B 67/10; E05B 67/14; E05B 67/22; E05B 17/2011; E05B 73/00; E05B 2047/0058; E05B 2047/0095

(57) ABSTRACT

A portable lock includes a wireless signal receiver. The lock may be unlocked by transmitting a wireless unlock signal from a portable device such as a cellular telephone. Various actuation mechanisms which may include a solenoid, motor or memory wire of a type that contracts when energized are provided in example embodiments. Self-locking embodiments are readily operated with one hand.

### TECHNICAL FIELD

This invention relates to portable locks. Some embodiments provide portable locks having locking mechanisms controlled by wireless signal(s). The signals may be sent from a portable device such as a smartphone or the like. Some embodiments provide self-closing locks.

### BACKGROUND

Portable locks may be used to secure portable items to stationary objects or to secure lockers, gates doors and the like by means of a hasp, chain or the like. One type of portable lock is a padlock of the type having an inverted U-shaped shackle which can be opened at the turn of a physical key. Locks employing U-shaped shackles are often inconvenient to attach with one hand, and can sometimes appear to be locked even when the shackle is not fully engaged.

Most mechanical locks can be picked at the keyway, or their physical keys copied. It is often cheaper to buy a new padlock than to re-key one if old keys have not been returned. Other problems with mechanical-keyed locks include keyways that expose the insides of the lock to tampering or damage, and the limited number of available key combinations. Combination locks provide a limited number of combinations and can be susceptible to cracking with patient application.

Some locks can be locked or unlocked using wireless signals. The signals may be infrared (U.S. Pat. No. 7,948,359). U.S. Pat. No. 7,382,250 discloses a dedicated key-fob for opening a lock. U.S. Pat. No. 7,334,443 discloses a physical key combined with an attached transceiver element. These technologies still require the user to carry a secondary physical key or fob in order to open each lock.

Some electronic locks use an RF activated motor to physically open the shackle of the lock, but this method requires an inefficient amount of power for a device that needs to operate reliably (U.S. Pat. No. 8,225,629, U.S. Pat. No. 7,948,359).

There remains a need for portable locks that are convenient and trustworthy to use.

### SUMMARY

The invention has a number of aspects. One aspect provides wirelessly-controlled locks. An example embodiment provides a wireless self-closing portable lock which allows a user to conveniently and securely operate one or more locks by means of a smart phone or similar wireless device. A system includes such a lock and a software application that can be executed on a smartphone or other portable device to control the lock to switch from a locked state to an unlocked state. In some embodiments the locks are self-closing.

Another aspect provides lock mechanisms that comprise a pivoting shackle that can be secured in a receiver in a lock housing. In some embodiments the shackle may have two distinct latched positions. In some embodiments the lock may provide a spring-loaded latching member and a locking member. The spring-loaded member may be arranged to prevent interference with the locking member when the lock is in a locked state.

Another aspect provides portable locks that have housings having openings covered by covers. The portable locks have striker members that are actuated to lock and unlock the locks. Members extending from the covers are restrained by the striker member when the striker member is in a locked configuration, thereby locking the covers in place over the openings. The covers may comprise battery covers in some embodiments.

Another aspect provides locks having an electrically-operated actuating mechanism comprising one or two racks driven by a pinion. The rack(s) carry engagement member(s) arranged to engage with a movable locking member such as a striker plate, shackle, or other element that must be moved to permit opening of the lock. The racks may be moved by rotating the pinion between a locked configuration wherein the engagement members engage the locking member to restrict motion of the locking member and an unlocked configuration wherein the engagement members permit motion of the locking member. In an example embodiment the pinion is driven by an electric motor. The pinion may be driven by reduction gearing such as a worm drive or planetary drive or gear train, for example. In some embodiments the gear ratio provided by the reduction gearing is in the range of about 50:1 to about 400:1. In an example embodiment the gear ratio is 200:1±10%. In one embodiment two racks are arranged such that the engagement members are moved toward one another to reach the locked configuration. In such embodiments the engagement members may, for example, engage notches on edges of a striker plate or other locking member. In other embodiments two racks are arranged such that the engagement members are moved apart to reach the locked configuration. In such embodiments, the engagement members may, for example, engage notches or indentations in inner edges of a shackle, striker plate or other locking member.

Another aspect provides lock mechanisms that include an electrical actuating mechanism in which one or more memory wire actuators is coupled to move a locking member between locked and unlocked configurations.

These aspects may be applied individually or in any combinations.

Further aspects and example embodiments are illustrated in the accompanying drawings and/or described in the following description.

### BRIEF DESCRIPTION OF THE DRAWINGS

The accompanying drawings illustrate non-limiting example embodiments of the invention.

FIG. 1a is an overview of an example portable wireless self-closing lock system showing the user remotely locking two self-closing locks by means of a wireless device. FIG. 1b shows the user opening both locks by the same means.

FIG. 2a is a side isometric exploded view of a pivot lock implementation of the self-closing lock system. FIG. 2b is a top isometric exploded view of the pivot lock implementation.

FIG. 3a is a side isometric semi-transparent view of a pivot lock in its open configuration. FIGS. 3b & 3c are corresponding views of a pivot lock in latched & locked configurations.

FIG. 4a is a side cutaway view of a pivot lock, while FIG. 4h is an end view.

FIG. 5a is a side isometric view of the basic latching-locking mechanism of the pivot lock, while FIG. 5b is an inside isometric view of an example pivot lock shackle including its (latch) pin divot.

FIG. 6a is a front isometric exploded view of an example clip lock implementation of the self-closing lock system. FIG. 6b is a rear isometric exploded view of the clip lock implementation.

FIG. 7a is a front view of the clip lock in its open configuration, while FIGS. 7b & 7c show corresponding views of the clip lock in latched & locked configurations.

FIG. 8a is a rear isometric view of the gate & hook interlocks of a clip lock in either latched or locked configuration. FIG. 8b is a front isometric view of the same interlocks in their open configuration.

FIG. 9a is a side isometric exploded view of the pivot lock (PLM). FIG. 9b is a top isometric exploded view of the pivot lock (PLM).

FIGS. 10a, 10b and 10c show isometric, end see-through and isometric cutaway views of the pivot lock (PLM) in its locked state.

FIGS. 11a, 11b and 11c are isometric, end see-through and isometric cutaway views of the pivot lock (PLM) in its latched state.

FIGS. 12a, 12b and 12c are isometric, end see-through and isometric cutaway views of the pivot lock (PLM) in its opened state.

FIG. 13a is an isometric overview of locking battery & carrier covers assembly, while FIG. 13b is a detailed view of same. (Note: certain elements that do not relate to illustrating how covers are secured are not shown)

FIG. 14a is an isometric overview of locking cattery & carrier covers insertion, while FIG. 14b is a detailed view of same.

FIG. 15a is an isometric detailed view of locking battery cover installation in the carrier (PLM), while FIG. 15b shows its rotation into the locked position while the pivot lock (PLM) is in the latched state.

FIG. 16a is an isometric detailed view of locking battery & carrier covers when the pivot lock (PLM) is in the locked state. FIG. 16b is a detailed cutaway top view of the tab stay hook engaging the tab stay inside the striker plate (PLM), and associated elements.

FIG. 17a is an isometric view of the battery cover (threaded) used to secure batteries inside the pivot lock (solenoid actuated). FIG. 17b is an isometric view of the pivot lock (motor actuated) with the external battery receiver and associated elements used to perform a jumpstart opening of the lock if internal batteries become inoperative. FIG. 17c is an isometric view of the PLM with an emergency jumpstart battery about to be inserted into the receiver, while FIG. 17d shows its completed installation.

FIG. 18a is a side cutaway overview of the PLM with the enclosed area highlighting the jumpstart and power elements enlarged for clarity in FIG. 18b.

FIG. 19 is an isometric view of a lock comprising a double latching engagement mechanism in a first latched position.

FIG. 20 is an isometric view of the lock of FIG. 19 in a second latched position.

FIG. 21 is an isometric view of the lock of FIG. 19 in an open state.

FIG. 22 is an isometric exploded view of the lock of FIG. 19.

FIG. 23a is an end view of the lock of FIG. 19 indicating plane A-A. FIG. 23b is a longitudinal cross-section of the lock of FIG. 19 on plane A-A in its locked state.

FIG. 24a is an end view of the lock of FIG. 19 indicating plane B-B. FIG. 24b is a longitudinal cross-section of the lock of FIG. 19 on plane B-B in its second latched position.

FIG. 25 is a partially exploded isometric view of the lock of FIG. 19.

FIG. 26a is a front view of the lock of FIG. 19 indicating plane C-C. FIG. 26b is a transverse cross section on plane C-C of the lock of FIG. 19.

FIG. 27a is a front view of the lock of FIG. 19 indicating plane D-D. FIG. 27b is a transverse cross-section in the plane D-D of the lock of FIG. 19

FIG. 28a is an isometric view of the lock of FIG. 19 in the locked state and a fob. FIG. 28b is an isometric view of the lock of FIG. 19 in the locked state with a fob engaging the lock. FIG. 28c is an isometric view of the lock of FIG. 19 in a latched state with a fob engaging the lock. FIG. 28d is an isometric view of the lock of FIG. 19 in the open state and a fob.

FIG. 29a is an isometric view of a lock comprising a dual rack locking mechanism in a locked state. FIG. 29b is an isometric view of the lock of FIG. 29a in an open state.

FIG. 30 is an exploded isometric view of the locking mechanism of the lock in FIG. 29a.

FIG. 31a is a front see-through view of the lock of FIG. 29a in the locked state. FIG. 31b is a top view of the locking mechanism of the lock of FIG. 29a in the locked state. FIG. 31c is a front view of the locking mechanism of the lock of FIG. 29a in the locked state.

FIG. 32a is a front see-through view of the lock of FIG. 29a in the latched state. FIG. 32b is a top view of the locking mechanism of the lock of FIG. 29a in the latched state. FIG. 32c is a front view of the locking mechanism of the lock of FIG. 29a in the latched state.

FIG. 33a is a front see-through view of the lock of FIG. 29a in the unlocked state. FIG. 33b is a top view of the locking mechanism of the lock of FIG. 29a in the unlocked state. FIG. 33c is a front view of the locking mechanism of the lock of FIG. 29a in the unlocked state.

FIG. 34a is an isometric view of the locking mechanism of the lock of FIG. 29a in the locked state. FIG. 34b is a top view a portion of the locking mechanism of the lock of FIG. 29a in the locked state. FIG. 34c is a top view another portion of the locking mechanism of the lock of FIG. 29a in the locked state.

FIG. 35a is an isometric view of the locking mechanism of the lock of FIG. 29a in the unlocked state. FIG. 35b is a top view a portion of the locking mechanism of the lock of FIG. 29a in the unlocked state. FIG. 35c is a top view another portion of the locking mechanism of the lock of FIG. 29a in the unlocked state.

FIG. 36 is a partially exploded isometric view of the lock of FIG. 29a.

FIG. 37a is an isometric view of a lock according to another embodiment that is similar to the lock of FIG. 29a in the locked state. FIG. 37b is an isometric view of a lock according to another embodiment similar to the lock of FIG. 37a in the unlocked state. FIG. 37c is an isometric view of the bottom of a lock according to another embodiment similar to the lock of FIG. 37a in the locked state.

| | |
|---|---|
| 10 | Portable Lock System |
| 12 | Wireless Device |
| 14 | Lock Software GUI |
| 16 | Wireless Signal |
| 18 | Opened |
| 20 | Latched |
| 22 | Locked |
| 24 | User Input |
| 26 | PIVOT LOCK (PL) |
| 28 | Housing (PL) |
| 30 | Pivot Drum |
| 32 | Shackle Cap |
| 34 | Carrier Cover |
| 36 | Battery Cover |
| 37 | Striker Spring Cup |
| 38 | Shackle Inlet |
| 40 | Pin Outlet |
| 42 | Carrier (PL) |
| 43 | Carrier Bay |
| 44 | Battery Well |
| 45 | Block Guide |
| 46 | Mechanism (PL) |
| 48 | Striker Plate |
| 50 | Latch Pin |
| 52 | Striker Spring |
| 54 | Spring Trap |
| 56 | Guide Bolt |
| 57 | Travel Guide |
| 58 | Guide Slot |
| 60 | Shackle |
| 62 | Pin Divot |
| 64 | Shackle Tang |
| 66 | Tang Entry |
| 68 | Tang Securement |
| 70 | Actuator (PL) |
| 72 | Locking Block |
| 73 | Block Fastener |
| 74 | Plunger |
| 76 | Solenoid |
| 78 | Plunger Spring |
| 80 | Pivot Spring Lock Plate |
| 82 | Pivot Spring |
| 84 | Pivot Spring Hook |
| 86 | Pivot Spring End |
| 88 | Pivot Spring Hole |
| 89 | Pivot Spring Slot |
| 90 | Shackle Cap Plate |
| 92 | Plate Washer |
| 94 | Washer Well |
| 96 | Tang Bolt |
| 100 | Electronics (PL) |
| 102 | Main Circuit Board |
| 104 | PL Receiver |
| 106 | Drive Circuit Board |
| 108 | Battery |
| 110 | CLIP LOCK (CL) |
| 112 | Housing (CL) |
| 114 | Hook |
| 116 | Front Cover |
| 118 | Rear Cover |
| 120 | Carrier (CL) |
| 122 | Mechanism (CL) |
| 124 | Gate |
| 126 | Gate Wheel |
| 128 | Gate Interlock |
| 130 | Hook Interlock |
| 132 | Gate Spring |
| 133 | Gate Spring Slot |
| 134 | Wheel Post |
| 136 | Actuator (CL) |
| 138 | Pawl Wire |
| 139 | Catch Wire |
| 140 | Ring Term. Crimp Fast. Assy. |
| 142 | Top Pawl Pulley |
| 144 | Catch Pulley |
| 146 | Bottom Pawl Pulley |
| 148 | Pawl |
| 150 | Pawl Post |
| 152 | Pawl Spring |
| 154 | Catch |
| 156 | Catch Spring |
| 158 | Catch Spring Holder |
| 160 | Electronics (CL) |
| 162 | Main PCB |
| 164 | CL Receiver |
| 166 | Switch Board |
| 168 | Battery |
| 170 | Battery Clip |
| 172 | Capacitor |
| 180 | PIVOT LOCK (PLM) |
| — | Housing (PLM) |
| 184 | Carrier (PLM) |
| 186 | Locking Carrier Cover |
| 188 | Tab Eyelet |
| 190 | Lightpipe Porthole |
| 192 | Carrier Cover Clip |
| 194 | Locking Battery Cover |
| — | — |
| 198 | Locking Tab |
| 200 | Tab Stay Hook |
| 202 | Battery Cover Hook |
| 204 | Cover Hook Receiver |
| — | Mechanism (PLM) |
| 208 | Striker Plate (PLM) |
| 210 | Tab Slot |
| 212 | Tab Stay |
| 214 | Pinion |
| 216 | Top Rack |
| 218 | Bottom Rack |
| 220 | Rack Stop |
| 222 | Stop Receiver |
| — | Actuator (PLM) |
| 226 | Motor |
| 228 | Reduction Gear |
| 230 | Output Shaft |
| 232 | Motor Restraint |
| 234 | Gear-motor Fastener |
| — | Electronics (PLM) |
| 238 | Contact Pad (−) |
| 240 | Isolation Ring |
| 242 | Contact Ring (+) |
| 244 | Conical Spring |
| 246 | Ganged Negative Plates (−) |
| 248 | Positive Plate (+) |
| 250 | Status LED |
| 252 | Status LED Lightpipe |
| 254 | External Battery Receiver |
| 256 | Wire to Bluetooth |
| 300 | Pivot Lock (DLE) |
| 308 | Striker |
| 309 | Ball Bearing |
| 310 | Tab Stop |
| 311 | Ball Bearing |
| 313 | Striker |
| 322 | Stop Receiver |
| 328 | Housing |
| 330 | Pivot Drum |
| 330a | Splines |
| 332 | Motor Restraint Casing |
| 332a | Circular Cross-Section Shaft |
| 332b | Protrusion |
| 332c | Protrusion |
| 333 | Spring Cover |
| 333a | Hexagonal Shaft |
| 333b | Contact Tab |
| 333c | Contact Tab |
| 335 | Compression Spring |
| 337 | Hinge |
| 337a | Splines |
| 337b | Hexagonal Interior |
| 338 | Shackle Inlet |
| 339 | Spring Cover Bolt and Washer |
| 352 | Striker Spring |
| 360 | Shackle |
| 364 | Shackle Tang |
| 384 | Carrier |
| 386 | Receiver |
| 388 | Fob |
| 400 | Padlock |
| 402 | Housing |
| 404 | Shackle |
| 406 | Motor |
| 408 | Reduction Gear |
| 410 | Output Shaft |
| 412 | Pinion |
| 414 | First Rack |
| 416 | Second Rack |
| 418 | First Striker Plate |
| 420 | Second Striker Plate |
| 422 | First Rack Stop |
| 424 | Second Rack Stop |
| 426 | First Ball |
| 428 | Second Ball |
| 430 | First Striker Plate Spring |
| 432 | Second Striker Plate Spring |
| 434 | Shackle Spring |
| 436 | Shackle Housing |
| 438 | Battery Housing |
| 440 | Battery |
| 442 | Electronics |
| 444 | Battery Cover |
| 446 | Receiver |
| 448 | Fixed End Indent |
| 450 | Free End Indent |

### DESCRIPTION

Throughout the following description specific details are set forth in order to provide a more thorough understanding to persons skilled in the art. However, well known elements may not have been shown or described in detail to avoid unnecessarily obscuring the disclosure. The following description of examples of the technology is not intended to be exhaustive or to limit the system to the precise forms of any example embodiment. Accordingly, the description and drawings are to be regarded in an illustrative, rather than a restrictive, sense.

This description describes portable locks and systems that include and/or work with portable locks. Features of the various example embodiments described below and illustrated in the drawings may be mixed with features of other described embodiments to yield further embodiments.

A portable lock as described herein may have any combination of features as described herein and may also leave out certain features. For example, portable locks according to some embodiments have an overall configuration as described herein but may have the same or different actuating mechanisms than the examples described herein. Portable locks according to some embodiments may have actuating mechanisms as described herein and may have overall configurations that are the same as or different from the example embodiments described herein. Portable locks according to some embodiments may include one or more locking covers as described herein and may otherwise be similar to or different from the example embodiments described herein. Portable locks according to some embodiments have locking mechanisms as described herein but have other features that are the same as or different from the example embodiments described herein. Portable locks according to any of these embodiments or other portable locks entirely may have optional features as described herein. Certain optional features and details of construction may have application in other contexts and so can be provided independently of other features described herein.

In some embodiments portable locks have an actuating mechanism that is controlled wirelessly to unlock and/or lock the portable lock. Such embodiments also include control electronics and a suitable wireless receiver.

Examples of optional features include means to jumpstart a discharged battery as described herein. Examples of details of construction include construction details of a secure battery and electronics bay, use of a carrier enclosed by a housing wherein lock components are supported on the carrier. These optional and detail features may also be applied in other embodiments.

The following example embodiments have been selected to illustrate applications of the invention. These example embodiments include locks having a shackle that is pivotally-mounted for movement across a lock opening (described as ‘pivot locks’), locks having overall configurations similar to carabiners (described as ‘clip locks’) and locks having overall configurations similar to padlocks (described as ‘padlocks’). Specific details of construction are illustrated for the described embodiments. However, the invention is more general than any of the specifically-described example embodiments.

Locks in some embodiments are designed so that they will normally be in only one of three possible states, namely locked, latched (unlocked, but unopened), or opened (i.e., the open position of the unlocked shackle or gate arm). A bias mechanism such as a spring may apply a force to the shackle or gate that tends to move the shackle or gate to the latched configuration.

### Example Wireless Lock System

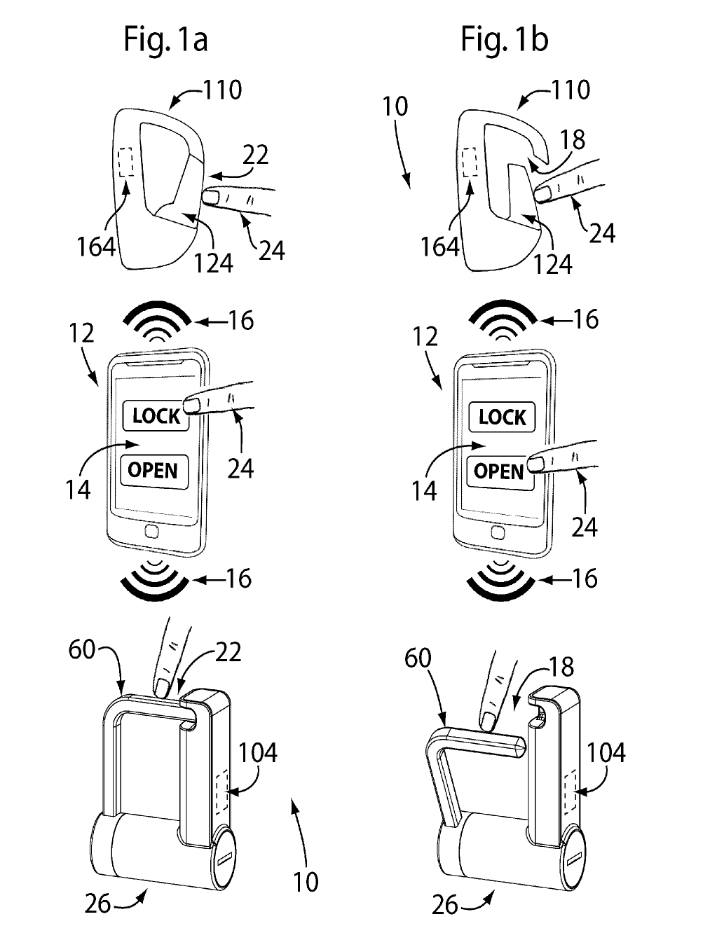

FIG. 1a is an overview of an example wireless-signal controlled portable lock system 10. A user input 24 to a lock software graphical user interface (GUI) 14 of a wireless device 12 (e.g. smartphone, tablet, pad device) causes the wireless device under control of the software to generate wireless signals 16A (e.g. Bluetooth™ signals) which are received by a receiver 104 (e.g. a Bluetooth™ receiver) in lock 26 and signals 16B which are received by a receiver 164 in another lock 110. The wireless signals 16A and 16B may be encrypted for security. These signals may be received by receivers 104, 164 and decoded at one or both of locks 26, 110.

GUI 14 may, for example, be provided by a dedicated software application. The user may, for example, obtain the application by downloading it into wireless device 12. After configuration with the lock the user is able to actuate 70 the locking mechanism 46 of one or more locks (e.g. lock 26 or 110) remotely by means of user input 24 to the software graphical user interface (GUI) 14 on their phone or other device.

Locks 26 and 110 may be configured to respond to the same or different signals. In this example embodiment, lock 26 has a pivot lock configuration and lock 110 has a clip lock configuration. In each of locks 26 and 110 internal electronics verify that the received signals are appropriate signals to authorize operation of the lock and, if so, actuate a locking mechanism (46 or 122) which locks 22 the gate 124 of the clip lock 110, and the shackle 60 of the pivot lock 26. FIG. 1b shows the user 24 opening 18 both locks 26 and 112 using the same portable device 12 as was used to lock both locks in FIG. 1a.

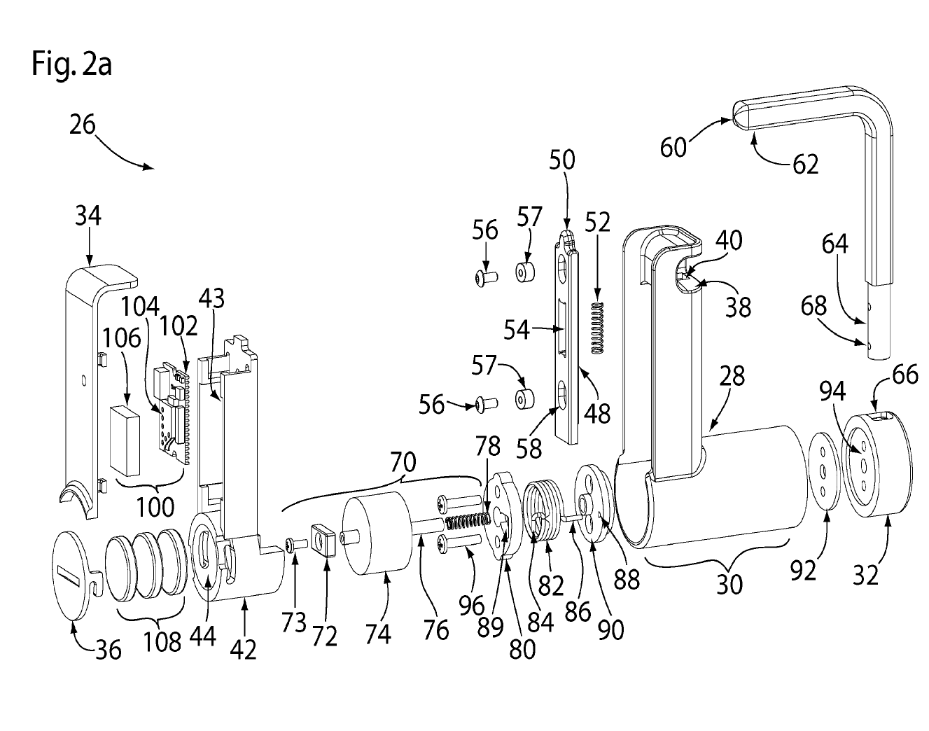

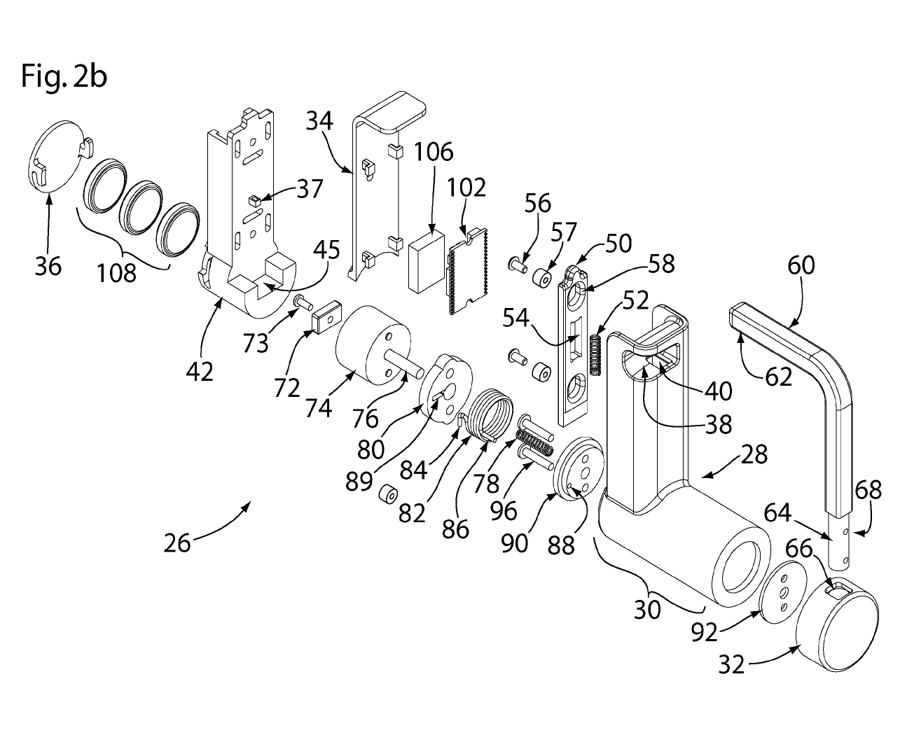

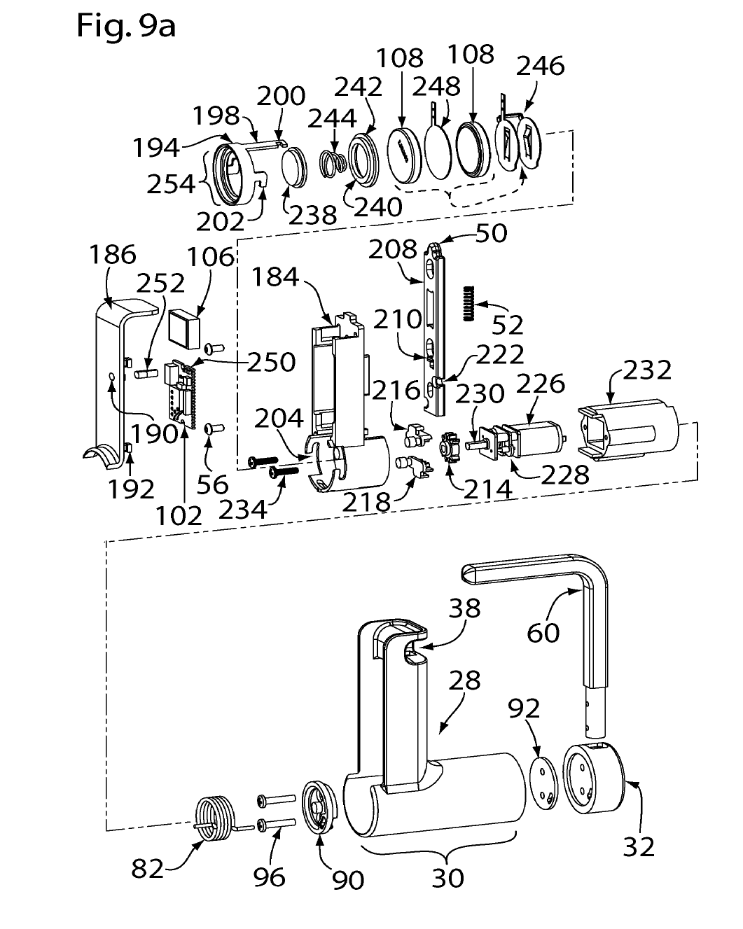

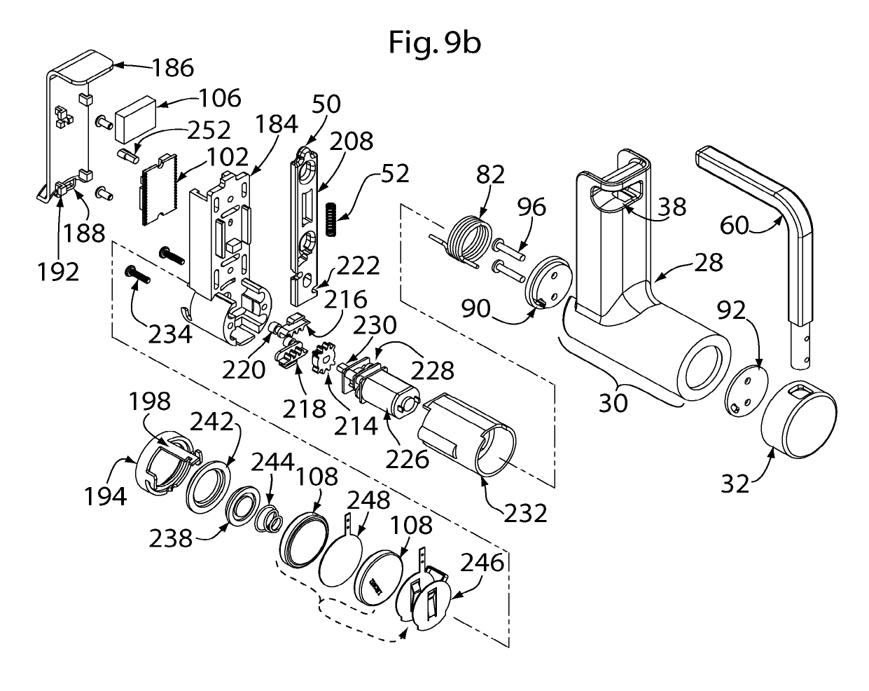

An example portable lock 26 which has a pivot lock configuration and a solenoid actuation mechanism is shown in FIGS. 2a through 5b. An example of a pivot lock 180 which employs a motor to actuate the lock mechanism, is shown in FIGS. 9a through 18b.

Any of the locks described herein may optionally comprise wireless receivers, electronics and an actuating mechanism controlled by the electronics such that the locks may be used in a wireless lock system.

Any of the locks disclosed herein may include signaling devices such as LEDs or other lamps, LCDs and/or speakers or buzzers or audio transducers operated by circuitry in the lock to provide visual and/or auditory indication of the lock's status or change of status. By this means, a visible and/or audible signal from the lock (e.g. 26 or 110) may be generated following receipt of a wireless signal 16 from a wireless device 12 or other control input (e.g. a signal from a fob) that changes the lock's status.

Locks as described herein may include any of a variety of actuation mechanisms. Example actuation mechanisms described herein use motors, solenoids, or memory wires to selectively move a locking member to lock or unlock a lock. A motor actuation mechanism may for example, use a rack and pinion mechanism or a worm gear to move a locking member. A worm gear or screw may, for example, advance or retract a locking member by turning as it engages one or more teeth, threads or projections on the locking member. A worm gear or screw may be turned directly by a motor or turned by way of a suitable transmission such as a speed-reducing gear train.

Example Pivot Lock with Solenoid Actuation Mechanism

One overall configuration for a portable lock is a pivot lock. A pivot lock has a shackle that is pivotally mounted to a housing. A free end of the shackle can be pivoted between an unlocked position and a locked position. In the unlocked position the free end of the shackle may be inserted into an aperture, such as a hasp, eye or the like, or may be passed behind an object, such as a part of an item to be secured by the lock. In the locked position the free end of the shackle is received by a receiver. When the lock is locked the free end is secured so that it cannot be removed from the receiver.

Lock 26 comprises a housing 28 which includes a pivot drum portion 30. Housing 28 encloses and protects components of lock 26 other than shackle 60 and shackle cap 32. A carrier 42 is insertable into a carrier bay 43 defined in housing 28 as shown in FIG. 2a. Most elements of lock 26 are installed into, or are secured by carrier 42. Carrier bay 43 is closed by a carrier cover 34. A battery well 36A is closed by a battery cover 36.

Actuator 70 is electrically operated and in this embodiment comprises a solenoid 74 with a plunger 76 which can be retracted to move a locking block 72 against the force of a plunger spring 78 by electrically energizing solenoid 74. In the illustrated embodiment locking block 72 is affixed by a fastener 73 to the end of the plunger 76. Locking block 72 may be extended toward carrier 42 where it blocks movement of a striker plate 48 and latch pin 50 away from a locked configuration.

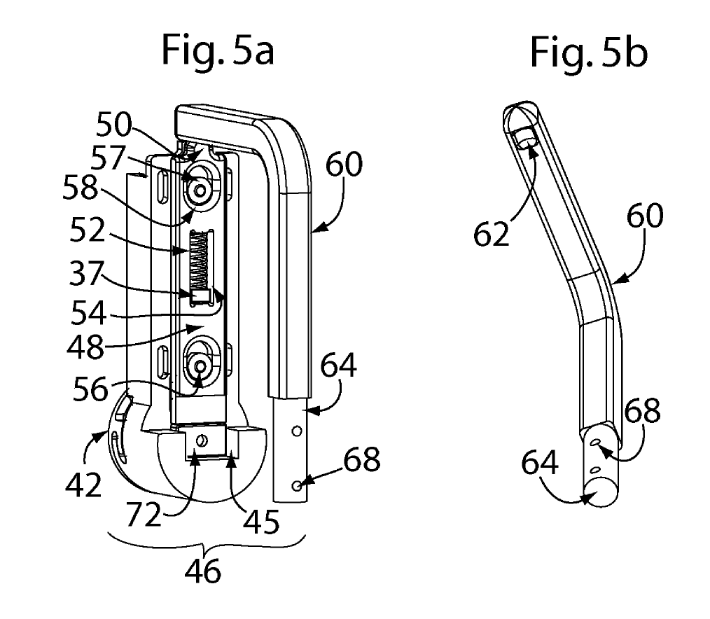

Locking/latching mechanism 46 includes: striker plate 48, pivot spring 82, and shackle 60. Striker plate 48 includes a latch pin 50, spring 52, spring trap 54, and guide slots 58. Cylindrical travel guides 57 are secured by guide bolts 56 to the face of carrier 42. Carrier 42 also supports a striker spring cup 37. Pivot spring 82 biases shackle toward its latched configuration. In the illustrated embodiment, pivot spring 82 is secured between a lock plate 80 and a shackle cap plate 90, whereby a hook 84 on spring 82 fits into a slot 89 of lock plate 80 and an end of spring 82 inserts into a hole 88 in cap plate 90. The pivot spring assembly is secured by tang bolts 96 into threaded holes 68 in the tang 64 of shackle 60 through corresponding holes in a plate washer 92 (which in some embodiments is made from a suitable plastic such as Delrin™) and a washer well 94 in the shackle cap 32. When assembled, latch pin 50 protrudes from the pin outlet 40 in the base of the shackle inlet 38 and into the pin divot 62 in shackle 60. (see FIG. 5b)

Electronics 100 includes a main PCB 102 with a wireless signal receiver 104, and a drive PCB 106. Electronics 100 are secured by a cover 34 into bay 43 of carrier 42. Batteries 108 are secured in a battery well 44 in carrier 42 by a cover 36.

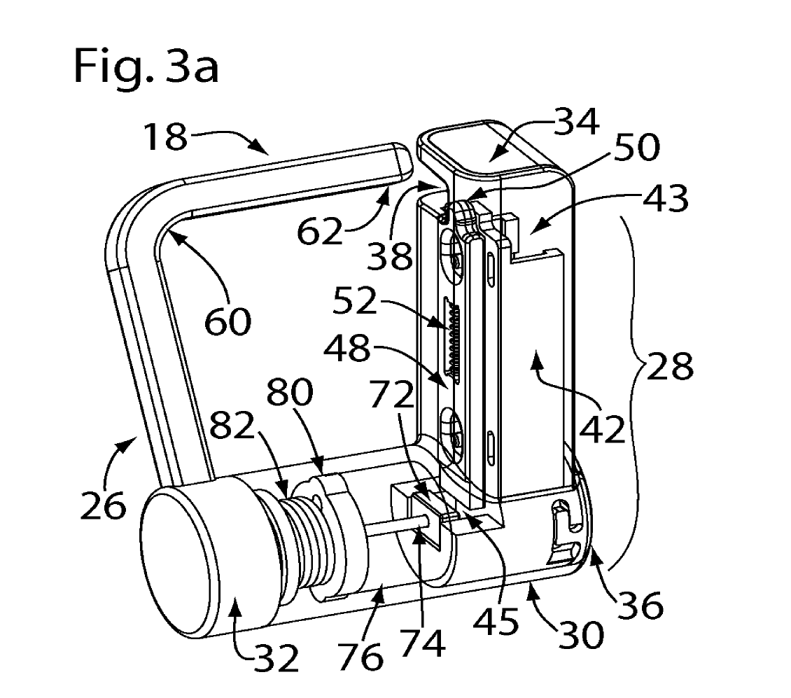

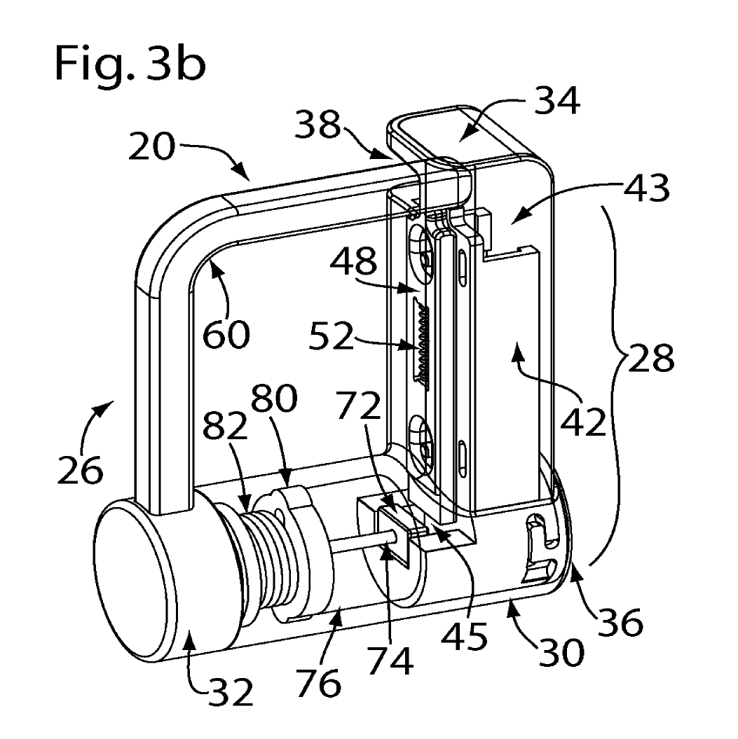

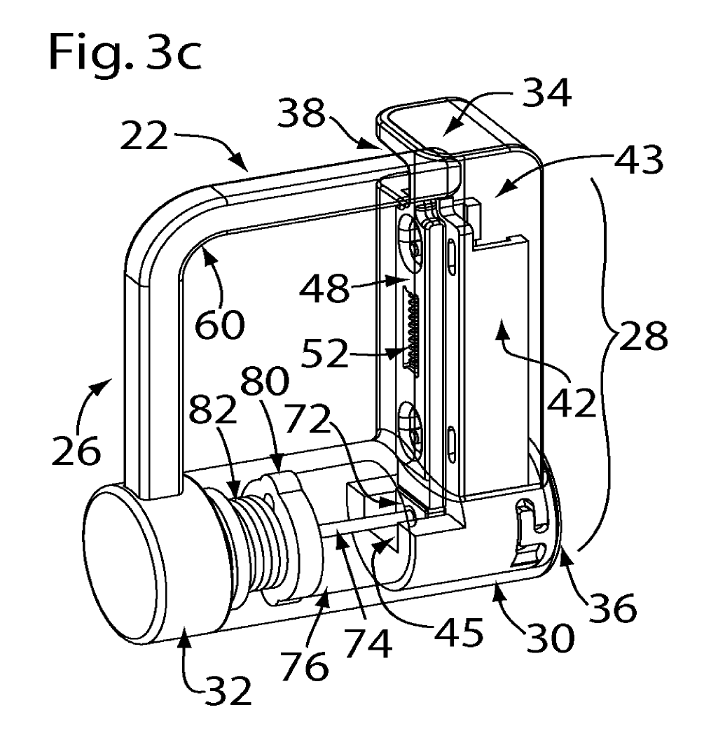

FIG. 3a is a side isometric semi-transparent view pivot of lock 26 in its open 18 configuration as a user pivots the shackle 60 against the torsional force of the pivot spring 82 by pushing on shackle 60. In this configuration, striker plate 48 can be manually depressed by latch pin 50 into the block guide 45 because solenoid 76 is energized and locking block 72 is retracted. When lock 26 is in the configuration of FIG. 3a, latching pin 50 does not prevent the user from pivoting the shackle 60.

When the free end of shackle 60 is seated in receiver 38, pin 50 engages divot 62 and in combination with the force exerted by pivot spring 82, holds shackle 60 with its free end engaged in receiver 38 (in this configuration, lock 26 is latched). FIG. 3b shows lock 26 in its latched 20 configuration, namely when the shackle 60 is released against the torsional force of the pivot spring 82 and the latch pin 50 of the striker plate 48 is seated in the pin divot 62 of the shackle 60. The user opens 18 the pivot lock 26 by applying sufficient force to overcome the striker spring 52 which pushes the striker plate 48 into the block guide 45, as well as against the force of the pivot spring 82. FIG. 3c shows lock 26 in its locked 22 configuration, where the striker plate 48 is prevented from releasing shackle 60 because plunger spring 78 is holding locking block 72 in place in block guide 45 when solenoid 76 is de-energized.

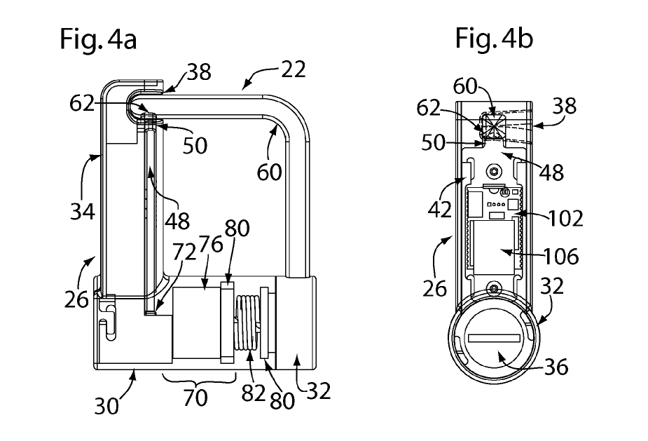

FIG. 4a is a side cutaway view of pivot lock 26 in the locked 22 configuration, exposing how latch pin 50 of striker plate 48 seats into pin divot 62 of the shackle 60, and is prevented from unlocking when the locking block 72 is extended under the plate 48 by a de-energized solenoid 76 and plunger spring 78. FIG. 4h is an end view of a pivot lock 26 without carrier cover 34, and exposing an end view in which one can see latch pin 50 seated in pin divot 62 of shackle 60 inside shackle receiver 38.

FIG. 5a is a side isometric view of lock mechanism 46 in its locked 22 configuration. Locking block 72 prevents movement of striker plate 48 and thereby holds latch pin 50 engaged in pin divot 62, thus holding the free end of shackle 60 in receiver 38 (see FIG. 4b). FIG. 5b is an inside isometric view of a pivot lock's 26 shackle 60 exposing the pin divot 62.

When locking block 72 is retracted by operation of an actuation mechanism, striker plate 48 is released and can move in a direction such that pin 50 is disengaged from divot 62 within the range of motion permitted by travel guides 57 and guide slots 58. Striker spring 52 which is supported between a striker spring cup 37 protruding from the face of carrier 42 and striker plate 48 biases striker plate 48 toward its locked configuration.

Housing 28 contains electronics 100 and striker plate 48. Pivot drum 30, which is part of or contiguous with housing 28 encloses actuator 70 and pivot spring 82. When lock 26 is unlocked, shackle 60 can pivot against the torsional force of pivot spring 82 by means of shackle cap 32 at the end of pivot drum 30. When lock 26 is locked, shackle 60 is secured by latch pin 50 of striker plate 48 which protrudes from pin outlet 40 inside receiver 38 and into pin divot 62 of shackle 60.

As shown in FIG. 3b, the latched 20 state is where the locking block at the end of the plunger 74 is retracted by the solenoid 76 which allows the striker plate 48 to freely move down into the guide slot 45 which allows the latch pin 50 to be retracted easily because it is only held in place by the force of the striker spring 52. Therefore, the latched 20 state is where the shackle is held against the shackle inlet 38 by the force of the pivot spring, and is pinned by the latch pin 50 against its pin divot 62 by the force of the striker spring 52. The user can easily open the shackle 60 by overcoming these forces, insert the lock into a hasp or similar attachment, and be assured that the pivot lock 26 will reliably return to the latched state 20 upon release.

As shown in FIG. 3c, the locked 22 state is where the locking block 72 at the end of the plunger 74 is released by the solenoid 76, and prevents the striker plate 48 from movement into the guide slot 45, and thereby prevents its latch pin 50 from being retracted. In the locked state 22, the latch pin 50 engages with the pin divot 62, securely locking the end of the shackle 60 into the shackle inlet 38. (See FIG. 4a)

The inside of carrier 42 provides a channel in which the striker plate 48 can move, while the outside provides a bay 43 in which electronics 100 are housed. Cylindrical travel guides 57 are secured by guide bolts 56 to the carrier 42 face, and delimit striker plate 48 travel as shown in FIG. 5a. The main PCB 102 includes the PL receiver 104 (Bluetooth™ or any equivalent wireless transmitting format), and any processing capability required to decode or convert the signal, and a power supply. The drive board 106 is used to supply the current needed to actuate the solenoid 76 when a control signal is received from the main PCB 102. Power is supplied by batteries 108 housed in a separate battery well 44 at the bottom of the carrier 42.

### Clip Lock

Another overall configuration for a lock is a clip lock. A clip lock comprises a frame which defines an opening. A pivotally-mounted gate extends across a gap in the periphery of the opening. When the clip lock is unlocked, the gate can be moved to allow objects (e.g. hasps, objects to be secured, etc.) to pass through the gap into the opening. When the clip lock is locked, the gate is secured in a configuration such that it extends across the gap. A clip lock may have a configuration generally like a carabiner. A bias mechanism may be provided to bias the gate to extend across the gap.

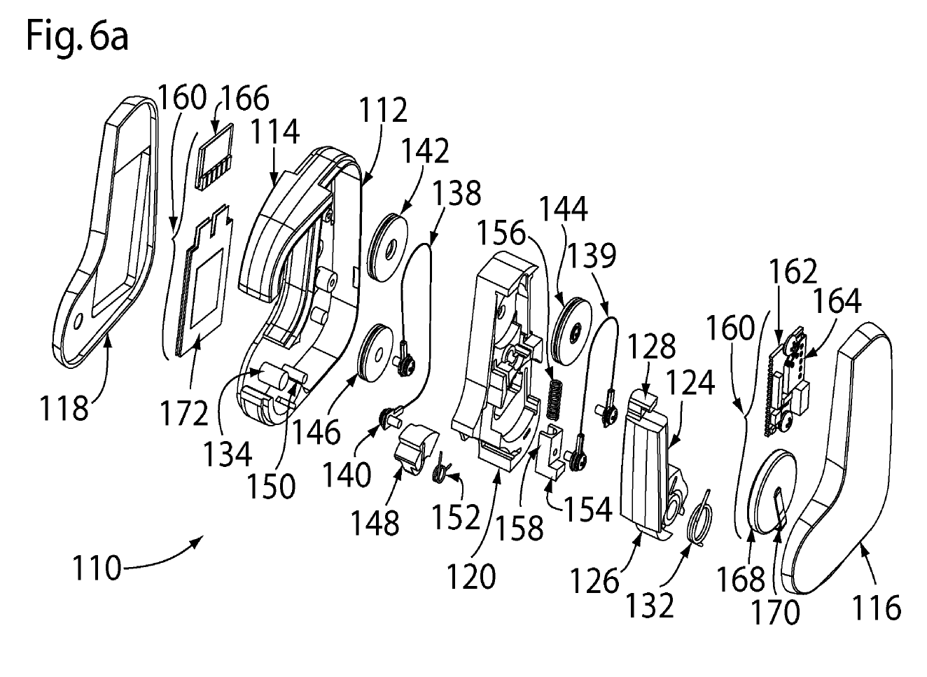

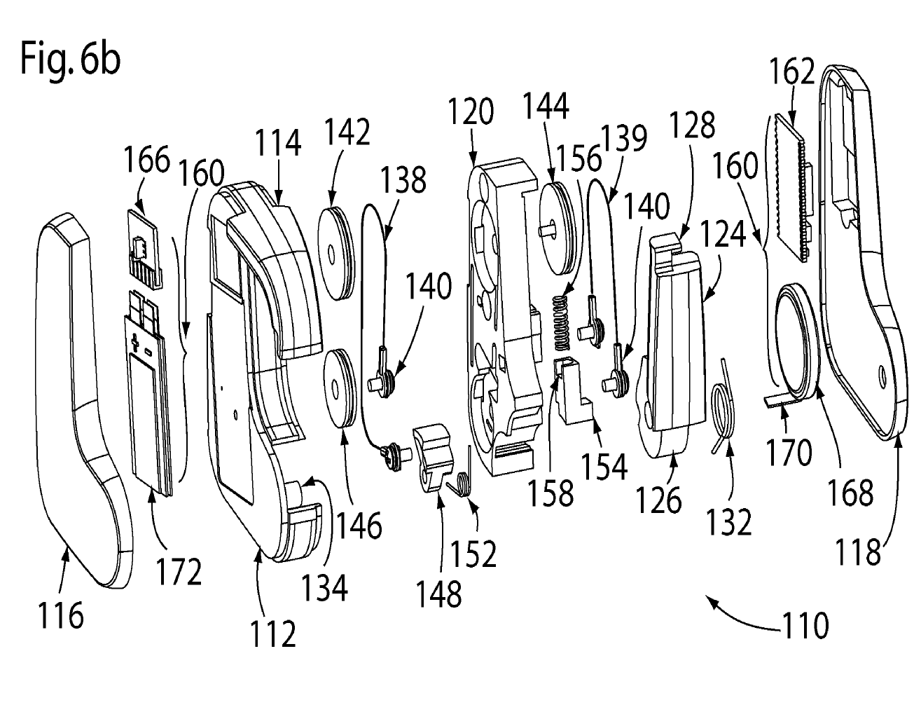

FIGS. 6a and 6b show an example clip lock 110. Clip lock 110 comprises a housing 112 which forms a hook 114. Most elements of clip lock 110 are installed into, or are secured by a carrier 120 that is received within housing 112 in a space enclosed by a front cover 116 and rear cover 118.

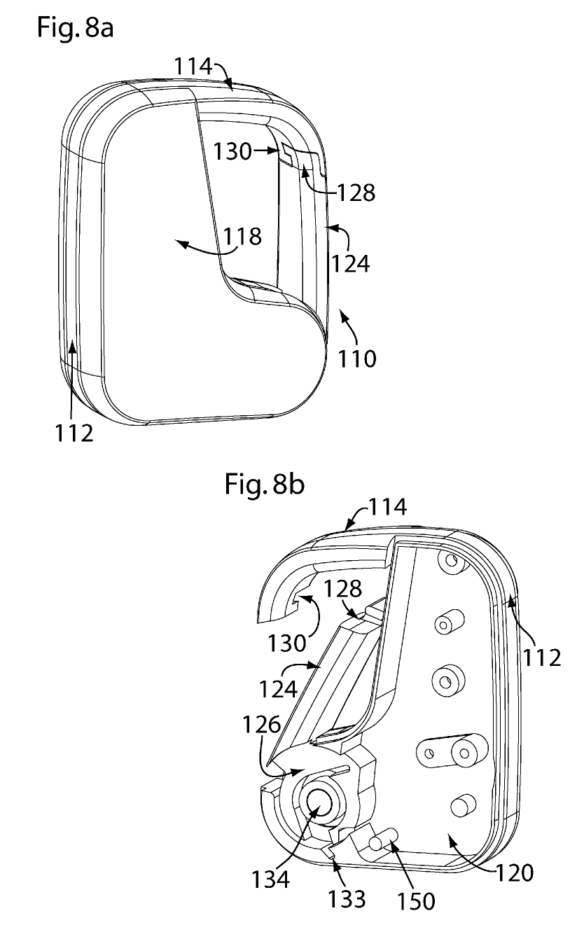

Clip lock 110 includes a locking mechanism 122 comprising a movable gate 124, which is the other half of the “clip” part of the lock. Gate 124 is pivotal about a wheel post 134 provided on housing 112. A gate wheel 126 is attached to or forms part of gate 124. Gate wheel 126 is also mounted to rotate about wheel post 134. Gate 124 may be secured to hook 114 by a gate interlock 128 interleaving with a hook interlock 130 (see FIGS. 8a & 8b). Gate spring 132 biases gate 124 against the hook 114, so that when the clip lock 110 is clipped onto an item to be locked, it automatically snaps closed.

A pawl 148 pivots on post 150 and is biased toward gate wheel 126 by a spring 152. Pawl 148 can engage gate wheel 126 to lock the gate wheel 126. A catch 154 with a seated spring 158 controls the position of pawl 148. Positions of pawl 148 and catch 154 are controlled by an actuation mechanism to lock and/or unlock clip lock 110.

Clip lock 110 comprises an actuator 136 which, in this example embodiment, uses electrically-contracting memory wire to actuate the locking mechanism. In alternative embodiments solenoids or other actuating devices are used to actuate the locking mechanism. The memory wire can be made to contract by passing an electrical current through it: The illustrated actuation mechanism comprises a pawl wire 138 and a catch wire 139 each comprising electrically-contracting memory wire. Pawl wire 138 is attached to pull on pawl 148, when energized. Catch wire 139 is attached to pull on catch 154, when energized. Pawl wire 138 and catch wire 139 are guided by pulleys which include a top pawl pulley 142, a catch pulley 144, and a bottom pawl pulley 146. Ends of each length of memory wire may be terminated with ring terminals 140 which connect to power wires. The ring terminals are electrically insulated, for example by non-conductive fasteners which, in the illustrated example embodiment include Delrin™ washers and nylon fasteners.

Clip lock 110 includes electronics 160 which include a main printed circuit board (PCB) 162 which includes a wireless receiver 164; a battery 168 and its conductive securement clip 170. Installed behind rear cover 118 is a switch board 166 and one or more flat pack capacitors 172.

In an embodiment of the clip lock having electrically-contracting memory wire for actuating the locking mechanism, when a user sends a signal to the electronics 160 to unlock the clip lock 110, the electronics 160 first energize pawl wire 138. When pawl wire 138 is energized, it contracts and pulls pawl 148 causing it to pivot into the disengaged position. With the pawl 148 in the disengaged position, the gate wheel 126 is free to rotate thereby allowing the gate 124 to move freely between a first position in which the gate interlock 128 is in contact with the hook interlock 30 and a second position in which there is a gap between the gate interlock 128 and the hook interlock 30. In this state, the lock is unlocked and can be opened. Pawl 148 may be held in its disengaged position after pawl wire 138 is no-longer energized by catch 154. Catch 154 may be engaged by briefly energizing catch wire 139. When catch wire 139 is subsequently de-energized, it expands and catch spring 156 biases catch 154 into a position such that it holds pawl 148 in the disengaged position. Once the catch 154 secures the pawl 148 in the disengaged position, the pawl wire 138 no longer needs to be energized to keep the pawl 148 in the disengaged position. This allows for efficient use of battery power. The lock may be locked, for example, by energizing pawl wire 138 to pull pawl 148 away from catch 154, energizing catch wire 139 to withdraw catch 154, deenergizing pawl wire 138 and then deenergizing catch wire 139.

Other embodiments provide alternative actuation devices, such as solenoids or other actuating means to move the pawl and the catch to lock and unlock a lock.

In an embodiment of the clip lock having electrically-contracting memory wire for actuating the locking mechanism, when a user sends a signal to the electronics 160 to lock the clip lock 110, the electronics 160 first energize the catch wire 139. When the catch wire 139 is energized, it contracts and pulls the catch 154, against the bias of the catch spring 156, away from the pawl 148. If the pawl wire is de-energized, the pawl 148, which is biased by pawl spring 152 towards the gate wheel 126, is then free to move towards the gate wheel 126. In this state, if the gate wheel 126 is rotated such that the gate interlock 128 is in contact with the hook interlock 130, then the pawl 148 will securably contact the gate wheel 126 thereby preventing the gate wheel 126 from rotating and thereby preventing the gate 124 from moving into an open position in which there is a gap between the gate interlock 128 and the hook interlock 130. In this state, the lock is locked and remains closed. In other embodiments of the clip lock, it is possible to use alternative methods, such as solenoids or other actuating means to move the pawl and the catch.

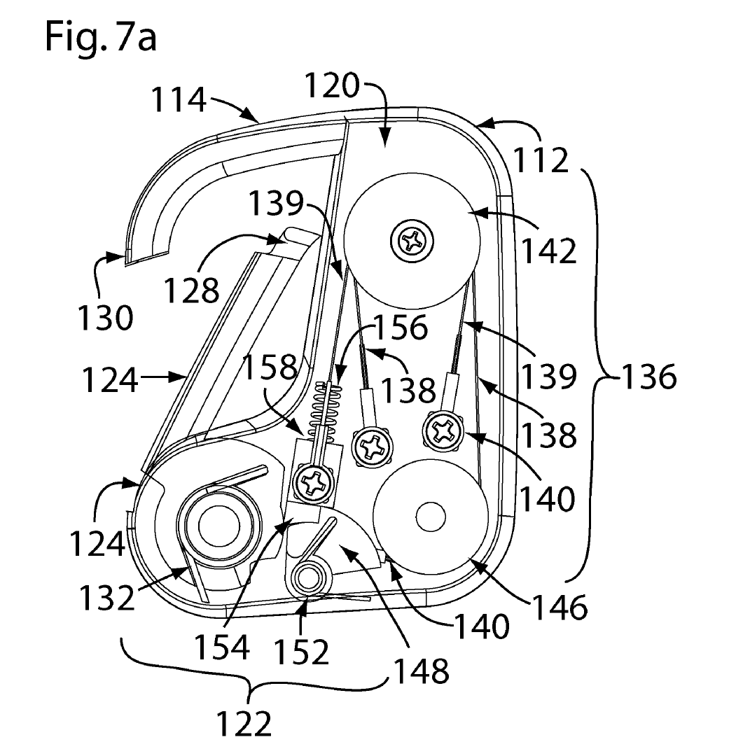

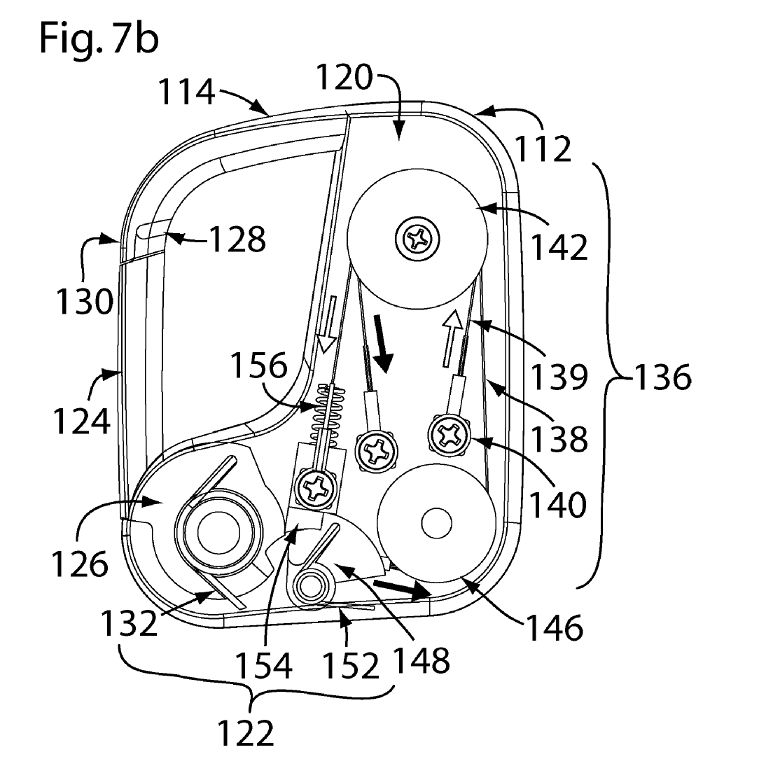

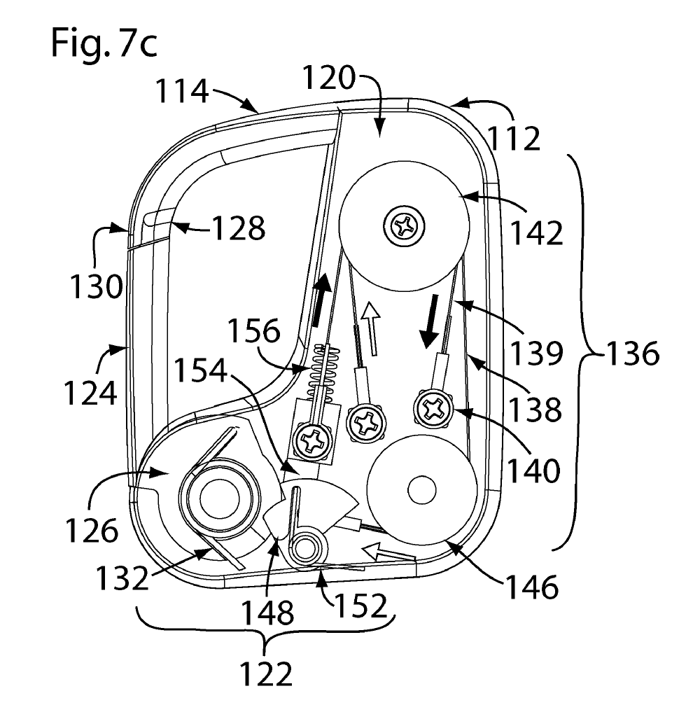

FIGS. 7a to 7c show housing 112 of clip lock 110 without electronics 160 or carrier 120 in order to reveal how control of the actuator 136 affects the configuration of locking mechanism 122. In FIGS. 7b & 7c, solid wide arrows denote an energized memory wire, and open wide arrows denote a non-energized, relaxed wire. In FIGS. 7b and 7c, catch pulley 144 is not visible because it is behind top pawl pulley 142. Pulleys guide the memory wire and normally rotate only enough to compensate for the strain on the wire bending around a corner when it is electrically energized.

FIG. 7a shows clip lock 110 in an open configuration, with the gate 124 able to rotate on its wheel 126 with only a push against the force of the gate spring 132. To put lock 110 into the open configuration pawl 148 is retracted by energizing pawl wire 138 and then held in place by catch 154. The force of catch spring 156 holds catch 154 in place. In the open configuration, clip lock 110 can be used as an unlocked self-closing carabiner-style clip device.

FIG. 7b shows clip lock 110 in a latched configuration. In the latched configuration, gate spring 132 causes gate 124 to fully engage hook 114 by means of the corresponding gate interlock128 and hook interlock130. The solid arrows denote the direction of the contracting energized pawl wire 138, while the hollow arrows denote the direction of the non-energized catch wire 139. By this means, the gate 124 is securely latched against the hook 114 unless external force is used to counteract the torsional force of gate spring 132.

FIG. 7c shows clip lock 110 in its locked configuration. Clip lock 110 may be placed into its locked configuration by energizing catch wire 139 and thereby retracting catch 154 against the force of catch spring 156, and thereby releasing the pawl 148; while pawl wire 138 is de-energized thus allowing pawl spring 152 to rotate pawl 148 into engagement in a corresponding notch in gate wheel 126, thereby securely locking gate 124.

FIG. 8a shows the gate interlock 128 and hook interlock 130 of a clip lock 110 in either latched 20 or locked 22 configuration. FIG. 8b shows clip lock 110 in an open configuration. In this view, one can see a gate spring slot 133 which receives an end of gate spring 132. FIG. 8b also shows how gate interlock128 and hook interlock 130 fit together to prevent further forward rotation of gate 124 and to increase the security of the clip lock 110.

The housing 112 of clip lock 110 is a shell that uses both sides to support device elements, is enclosed by front 116 and rear 118 cover plates, and supports a contiguous stationary hook 114 which mates with a gate 124 arm which rotates around a contiguous gate wheel 126 and creates the lock. Interlocks increase the security of the clip lock 110 by preventing the hook 114 from being forced or bent away from gate 124. A carrier 120 supports internal actuator 136 and mechanism 122 and is inserted into the front of the housing 112. (see FIGS. 6a & 6b)

As shown in FIG. 7b, the latched 20 state is where the pawl 148 is retracted by the energized pawl wire 138 while the catch 154 secures the pawl 148 by means of its spring 156, and because the catch wire 139 is not energized. This allows the gate wheel 126 to rotate freely so that the gate 124 may be opened when force is applied, but when latched is held closed by the force of the gate spring 132. By this means, the clip lock 110 may be used as a reliably-operating carabiner device when the locking mechanism is disengaged as shown.

As shown in FIG. 7c, the locked 22 state is where the pawl 148 is left free to rotate by de-energizing the pawl wire 138, and energizing the catch wire 139 so that the catch 154 releases the pawl 148 so that its spring 152 pivots the pawl 148 into a notch in the gate wheel 126, which secures the gate 124 in the locked position. To move from locked 22 to latched 20 state, the reverse steps are taken, namely, the catch wire 139 is released, the pawl wire 138 is energized, causing the pawl 148 to retract, and as it clears the catch 154, the catch spring 156 forces it downwards to prevent the pawl 148 from stopping the gate wheel 126 from rotating freely.

The rear of housing 112 contains some of the electronics 160, namely the capacitor(s) 172 and related switch board 166, while the main PCB 162 with its receiver 164 and the battery 168 overlay actuator and mechanism elements in front of the housing 112. (see FIGS. 6a & 6b) As with the pivot lock 26, similar circuitry is used to receive a wireless signal, decode, process, and send a control signal to the actuator 136. In this case the actuator 136 is comprised of lengths of memory wire, or flexinol, which has the property of contracting in length when electrically energized. Pulleys are used to guide the memory wires, reduce kinks and to extend the length of the memory wire used for more consistent actuation. Capacitors 172 are used to boost the current to activate the memory wires, and their output is controlled by a command from the main PCB 162 which tells the switch board 166 to select whether the pawl wire 138 or the catch wire 139 are energized.

Example Pivot Lock with Actuating Motor

### Motor Actuation

FIG. 9a shows an exploded view of another example pivot lock 180. Pivot lock 180 is similar to pivot lock 26 except that is has an actuation mechanism that includes a motor and has optional features including improved locking battery & carrier covers, and a means to externally power pivot lock 190 so it may be opened even if internal batteries 108 fail. Some parts of pivot lock 180 that are the same as or similar to corresponding parts of pivot lock 26 are identified by the same reference numbers as the corresponding parts of pivot lock 26. Features of pivot lock 180 may also be applied in other embodiments. For example the improved battery and electronics bay securement and/or means to power lock 180 even if it has a discharged battery may also be used in other embodiments.

Some parts of pivot lock 180 that differ from those illustrated in pivot lock 26 are a Carrier 184 with cover hook receiver(s) 204; a striker plate 208 with a tab slot 210 and stop receiver(s) 222; a locking carrier cover 186 with a tab eyelet 188 (see FIG. 9b), carrier cover clips 192 and a lightpipe porthole 190 with a status LED

Lightpipe 252 directs light from status LED 250 on main circuit board 102 to porthole 190.

Lock 180 has an actuation mechanism comprising a motor 226 with an integral reduction gear 228 and output shaft 230 keyed to a pinion 214. Pinion 214 engages one or more racks. Top rack 216 and bottom rack 218 are shown.

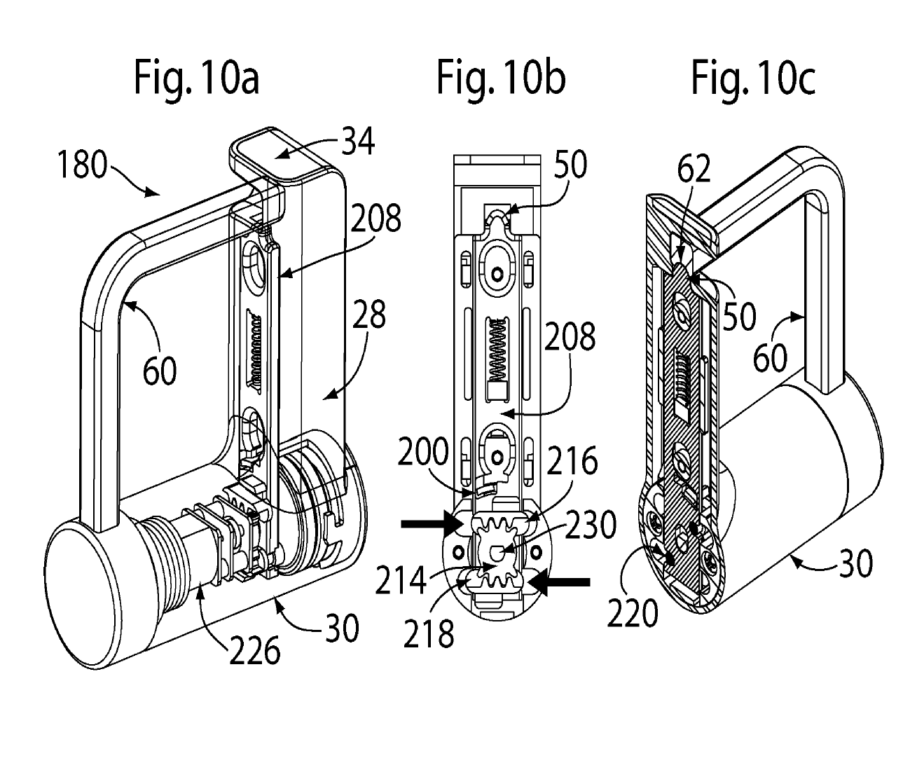

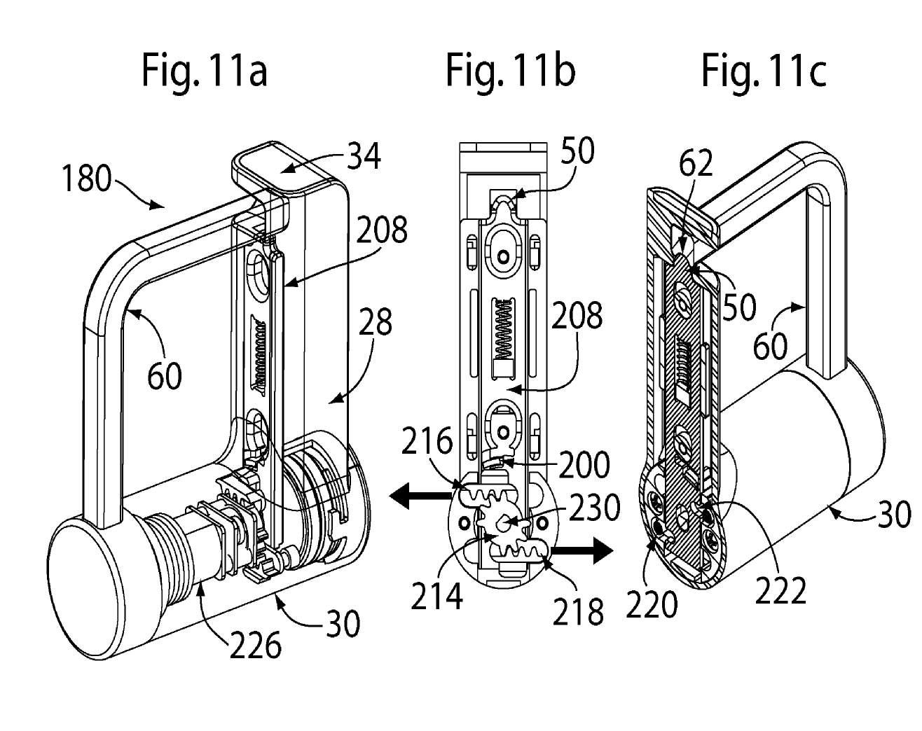

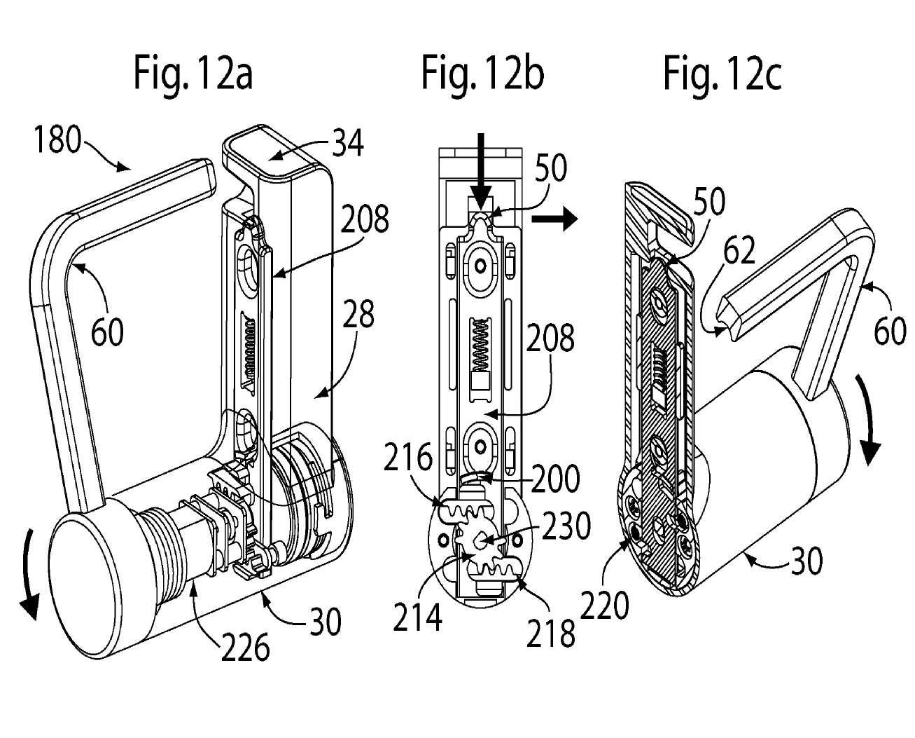

The state (locked-latched-opened) of pivot lock 180 is determined primarily by the position and freedom of movement of striker plate 208, and the position of pinion 214, top rack 216, bottom rack 218 and rack stop(s) 220. FIGS. 10a, 10b and 10c show pivot lock 180 in its locked state. FIGS. 11a, 11b and 11c show pivot lock 180 in its latched state and FIGS. 12a, 12b and 12c show pivot lock 180 in its opened state.

FIGS. 10a, 10b and 10c to 12a, 12b and 12c show locked, latched, and open states of the pivot lock 180, respectively. As with the pivot lock (PL) 26, a wireless signal 16 triggers the actuator, which in this example embodiment comprises a geared motor 226 with a keyed output shaft 230 which rotates a pinion 214 wheel which slides the top rack 216 and bottom rack 218 outwards to latch, and inwards to lock the striker plate 208 in place. As with the pivot lock (PL) 26, a pivot lock 180 in the latched state allows the latch pin 50 of the striker plate 208 to be depressed against the striker spring 52, thereby allowing the user to manually rotate the shackle 60 against the force of the pivot spring 82 and thereby release the shackle from the shackle inlet 38 and open the lock as shown in FIGS. 12a, 12b, and 12c. As shown in FIG. 9b, the motor 226 is prevented from inadvertent rotation by being secured inside the motor restraint 232 casing, as well as by securing the gear assembly 228 to the bottom of the carrier 184 by means of gear-motor fasteners 234. By this means, the motor actuation is reliable and secure.

### Locking Covers

A wirelessly actuated lock may be less vulnerable to combinatorial methods of unlawful entry, but if one can gain access to the interior of the lock housing, the lock may be vulnerable to defeat. For this reason, a lock may be constructed so that means of access to the interior such as battery and carrier covers are secured while the lock is in the locked state. Locks according to any of the embodiments as described herein as well as locks of other designs may include one or more covers that can be opened or removed only when the lock is in an unlocked state.

Lock 180 has a locking battery cover 194 and a locking carrier cover 186. Battery cover 194 has a member that interacts with striker plate 208 such that the cover cannot be removed when lock 180 is in its locked configuration. Battery cover 194 holds carrier cover 186 in place such that carrier cover 186 can be removed only after battery cover 194 has been removed.

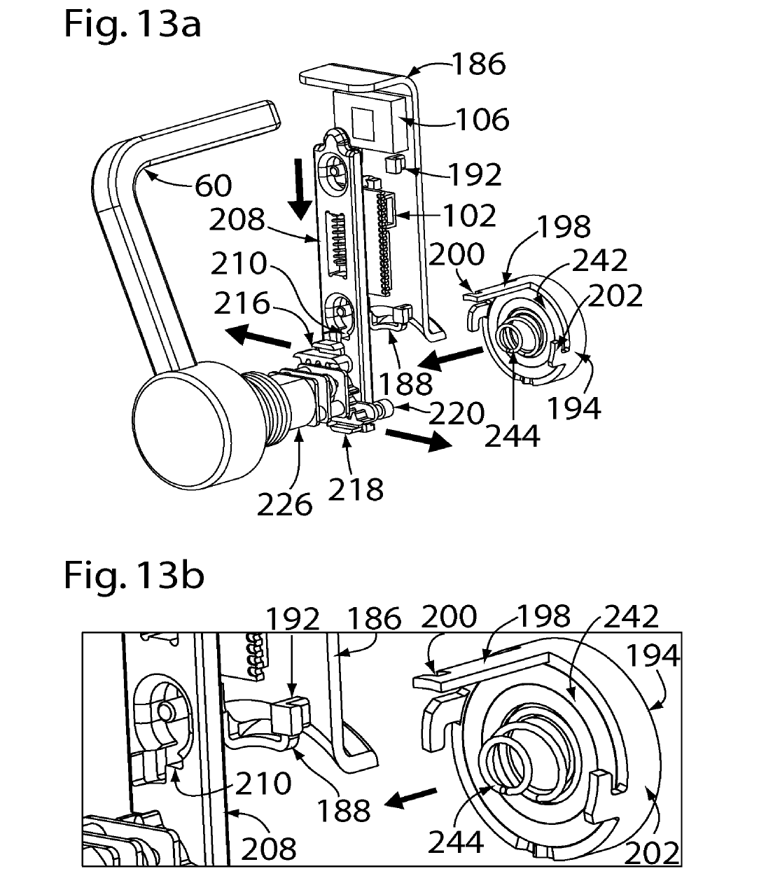

FIGS. 13a and 13b show locking battery cover 194 and locking carrier cover 186 while pivot lock 180 is in the open state. Some elements not related to illustrating how each cover is secured are not shown in FIG. 13b. Locking battery cover 194 includes a locking tab 198 with a tab stay hook 200 which fits through a tab eyelet 188 at the bottom of the locking carrier cover 186, as well as through a slot 210 in striker plate 208. FIGS. 13a and 13b also show the open positions of top rack 216 and bottom rack 218. In the open positions, rack stop(s) 220 are not engaged with the corresponding stop receiver(s) 222 on each side of striker plate 208.

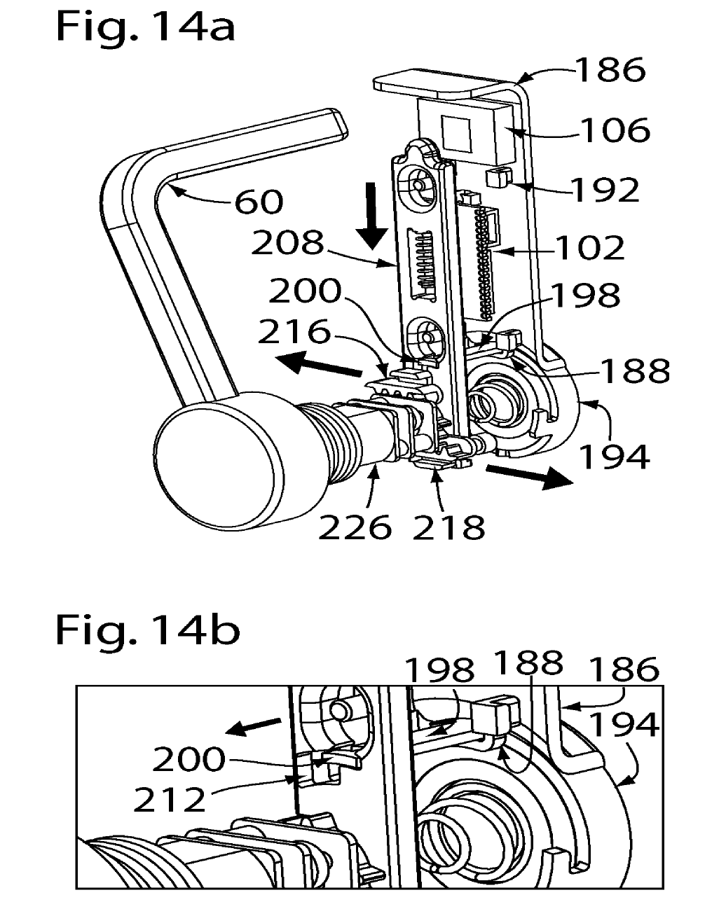

FIGS. 14a and 14b show the insertion of the locking battery cover 194 and locking carrier cover 186 while pivot lock 180 is in the opened state.

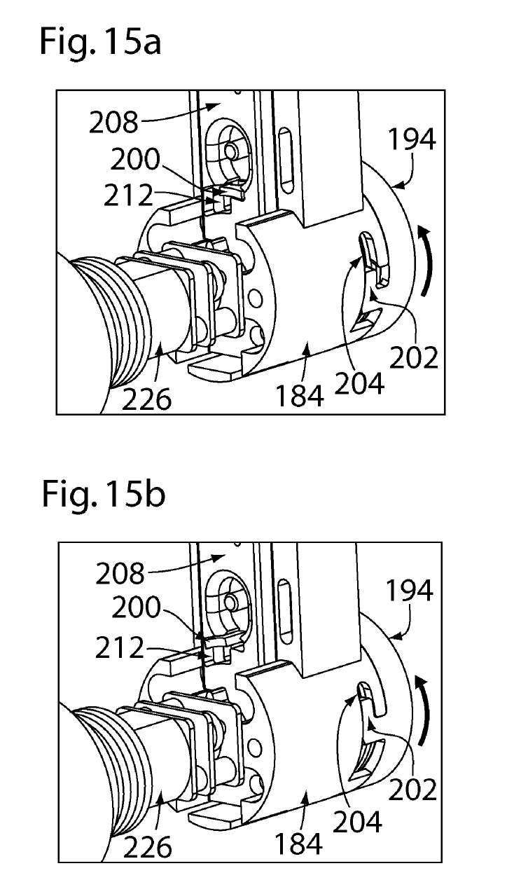

FIG. 15a shows the assembly of locking battery cover 194 to carrier 184 while pivot lock 180 is in the open state. Battery cover hook 202 engages cover hook receiver 204. FIG. 15b shows the rotation of the locked battery cover 194 into its locked position, including engagement of its tab stay hook 200 with the tab stay 212 in striker plate 208. When the locked battery cover is in this position, pivot lock 180 is in the latched state, so that striker plate 208 remains movable vertically.

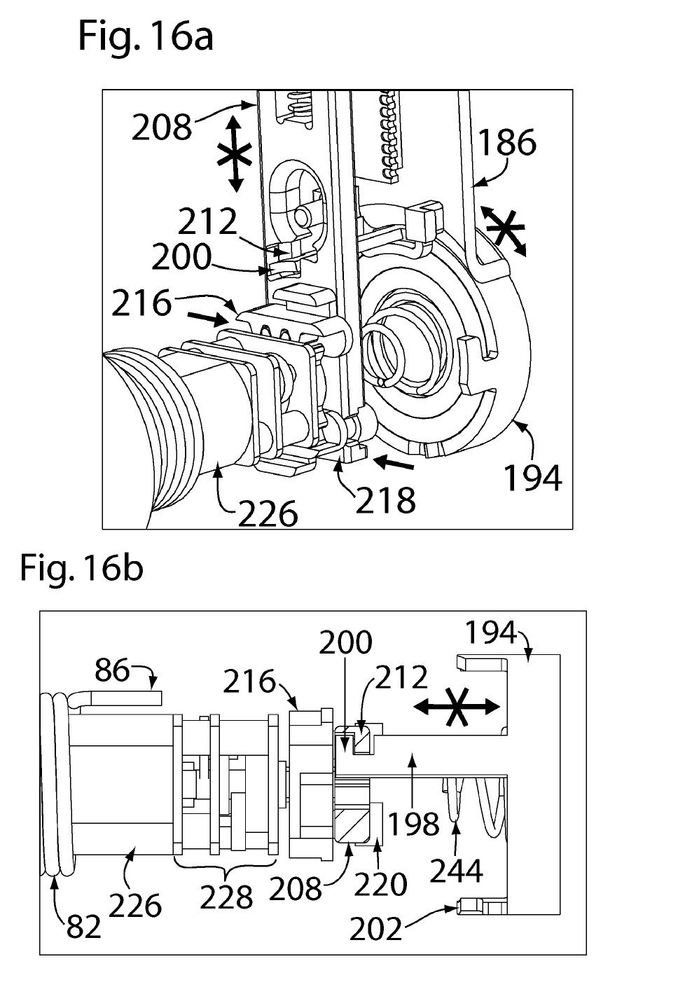

FIG. 16a shows locking battery cover 194 and locking carrier cover 186 when pivot lock 180 is in the locked state. In this state, top rack 216 and bottom rack 218 bind striker plate 208 by engaging receivers 222. Battery cover 194 and locking carrier plate 186 are locked in position as shown by the illustrative arrows.

FIG. 16b shows tab stay hook 200 engaging the tab stay 212 inside striker plate 208 which prevents removal of the locked battery cover 194. Also shown are the reduction gear assembly 228 of motor 226 and the pivot spring end 86 of pivot spring 82.

As shown in FIGS. 13a through 16b, once locking carrier cover 186 is secured to the upper body of housing 28 by means of carrier cover clip(s) 192, locking tab 198 of battery cover 194 can fit through the tab eyelet 188 at the bottom of the carrier cover 186 and then through the tab slot 210 of striker plate 208. (see FIGS. 13a 13b, 14a, 14b) As the locking battery cover 194 is rotated into place, tab stay hook 200 prevents cover 194 from being removed, while also permitting the free vertical movement of the striker plate 208 when in the latched state. (see FIGS. 15ab, 16b) Finally, when lock 180 is in the locked state, tab stay hook 200 is seated at the bottom of tab stay 212 (see FIG. 16a), thereby preventing the rotation of the locking battery cover 194. By this means, pivot lock 180 in the locked state is secure from external access.

A locking cover as described herein may be situated to provide access to interior components of a lock (e.g. batteries, circuit boards, mechanical components) for repair or replacement of such components Such locking covers may also, or in addition be used to control access to small objects such as keys for other locks, etc.

### External Jumpstart

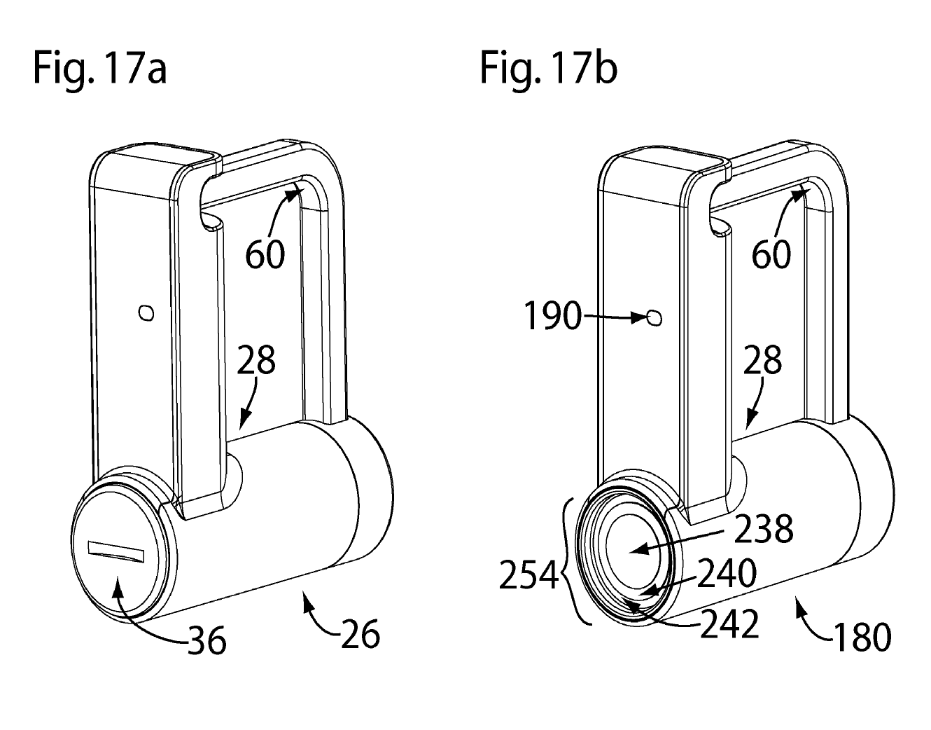

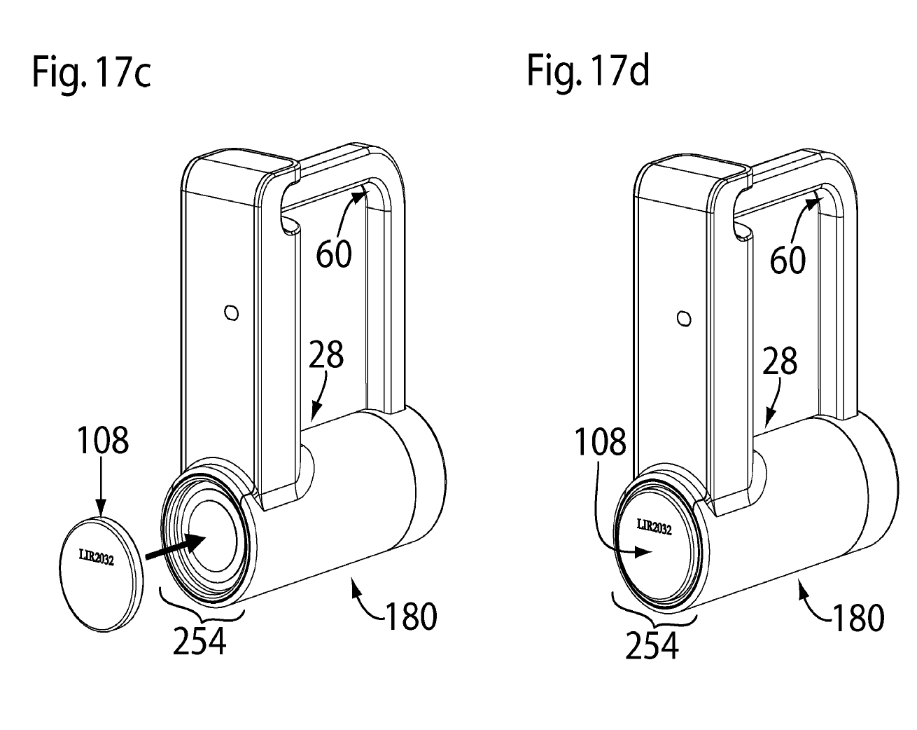

An authorized user may need to be able to open a lock even if the internal batteries die. For example, if pivot lock 180 is locked and has a dead battery, the user is prevented from accessing the lock housing 28 in order to change batteries by locking battery cover 194. Lock 180 has a receiver 254 which is accessible when lock 180 is locked. An external battery 108 may be inserted into receiver 254 (see FIGS. 17b, 17c and 17d). Receiver 254 may, for example be provided on the outside of locking battery cover 194 Along with the wireless unlocking signal 16, and a means to bypass the dead batteries such as a mode switch or similar disconnect, emergency opening of lock 180 is possible. Such an external jumpstart system may be provided on virtually any electrically-operated lock.

FIG. 17a is an isometric view of pivot lock 26 with its battery cover 36 (rotating) used to hold batteries inside the lock body as shown in FIG. 2a. FIG. 17b is an isometric view of pivot lock 180 with the external battery receiver 254 (part of the locking battery cover 194 shown in FIG. 9a) including its contact pad 238, isolation ring 240 and contact ring 242. FIG. 17c is an isometric view of pivot lock 180 with an emergency jumpstart battery 108 about to be inserted into receiver 254, while FIG. 17d shows its completed installation.

Lock 180 includes an external battery receiver 254. Battery receiver 254 includes a disc-like negative contact pad 238, an isolation ring 240, a positive contact ring 242, and a conical spring 244. Power from an external battery 108 (see FIG. 17c) may be applied to power lock 180 using battery receiver 254. In lock 180, internal batteries are configured in parallel with a central positive plate 248 between two inward facing batteries 108 then sandwiched between ganged negative plates 246 as shown by the hatched bracket and arrow.

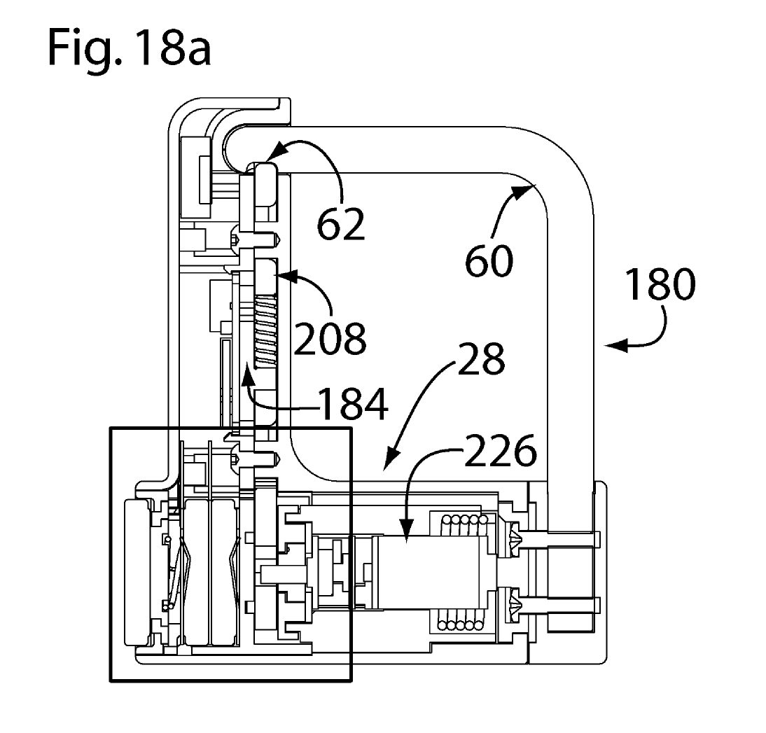

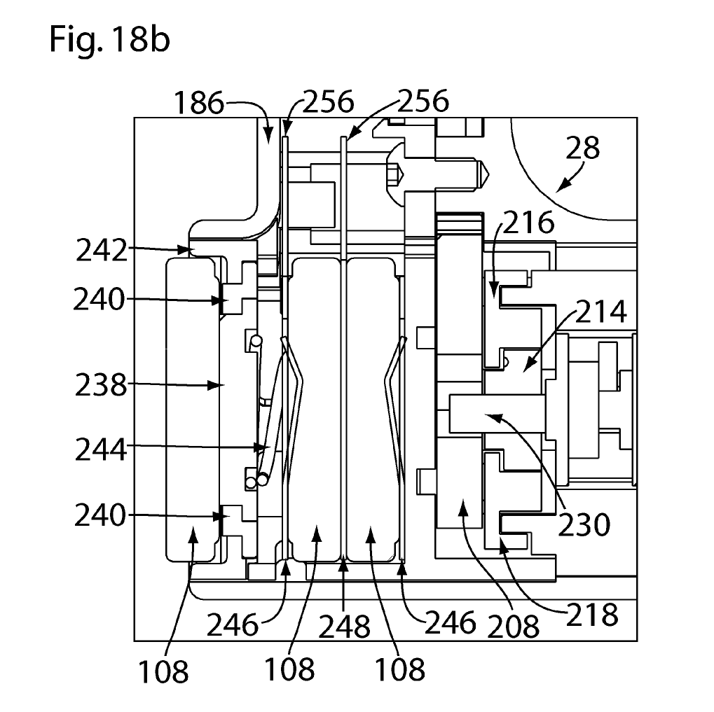

FIG. 18a is a side cutaway overview of pivot lock 180. FIG. 18b is an enlarged view of area 18b of FIG. 18a which includes external battery jumpstart and internal power elements. The positive side of each internal battery 108 contacts positive plate 248 and the negative sides of the sandwich are enclosed by ganged negative plates 246. Each plate termination connects to a wire to Bluetooth™ receiver 256 and any other parts of the lock that require power as needed. An external battery 108 is shown in contact with the negative contact pad 238 and its spring 244, as well as with the positive contact ring 242. Note that a switch (not shown) may be provided to disconnect the external battery elements when not needed and to prevent possibly damaging multiple power sources or shorting.

FIG. 18b highlights the elements of this method, with the exception of the means to disconnect the shown connection between the contact pad 238, the spring 244, and the first ganged plate 246. A simple mode switch breaking contact between the spring 244 and the negative plate 246 may suffice, while a more complex means of using a peripheral spring to allow the entire contact area to be pressed inwards when the external battery is inserted, so that only then will there be connection overriding the dead internal batteries. An external power mode switch can be provided such that, when the lock is in normal operation, the conducting surfaces of external battery receiver 254 area cannot electrically connect to any active internal components. When the internal batteries are dead, and an emergency battery is in place, there needs to be a means to shunt its power inside to open the lock, and for this reason, a mode switching means can be provided.

### Double Latching Pivot Lock

FIGS. 19 to 27 show a pivot lock 300 which has added security features. Pivot lock 300 is similar to pivot lock 180 except that it includes an additional anti-rotation mechanism for arresting rotation of the shackle when locked; it provides an additional shackle arm position; and it has separate latching and locking balls.

FIGS. 19, 20 and 21 respectively show lock 300 in: a first latched configuration; a second latched configuration; and an open configuration. As shown in FIGS. 19 and 20, shackle 360 can rotate as in previously disclosed embodiments.

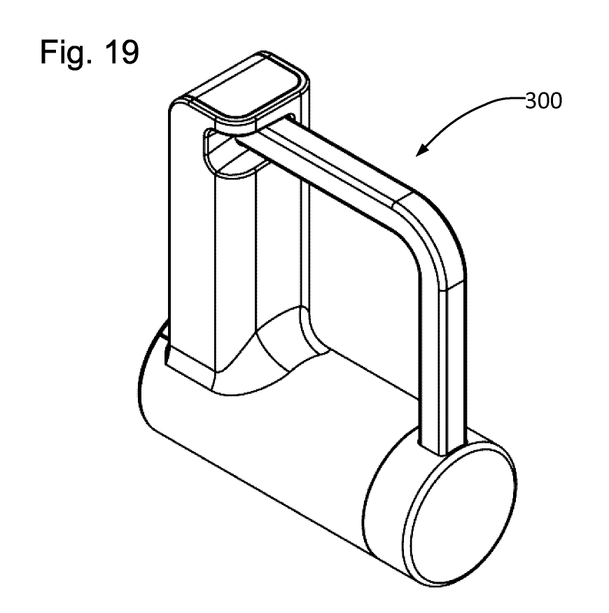

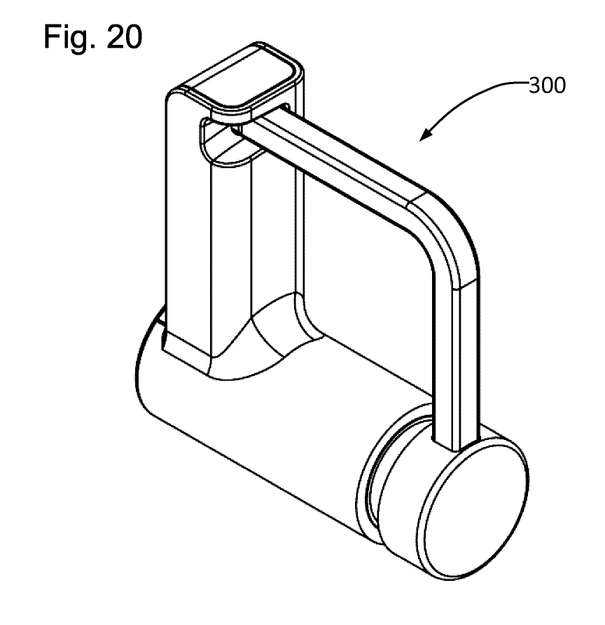

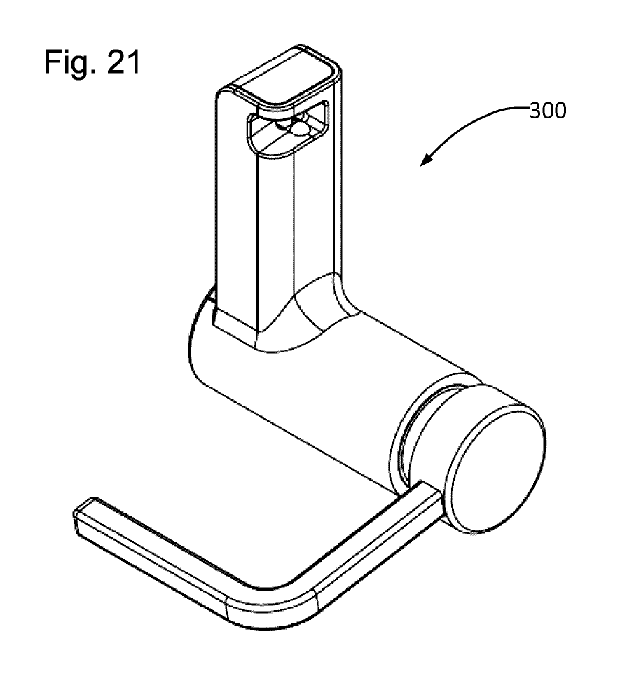

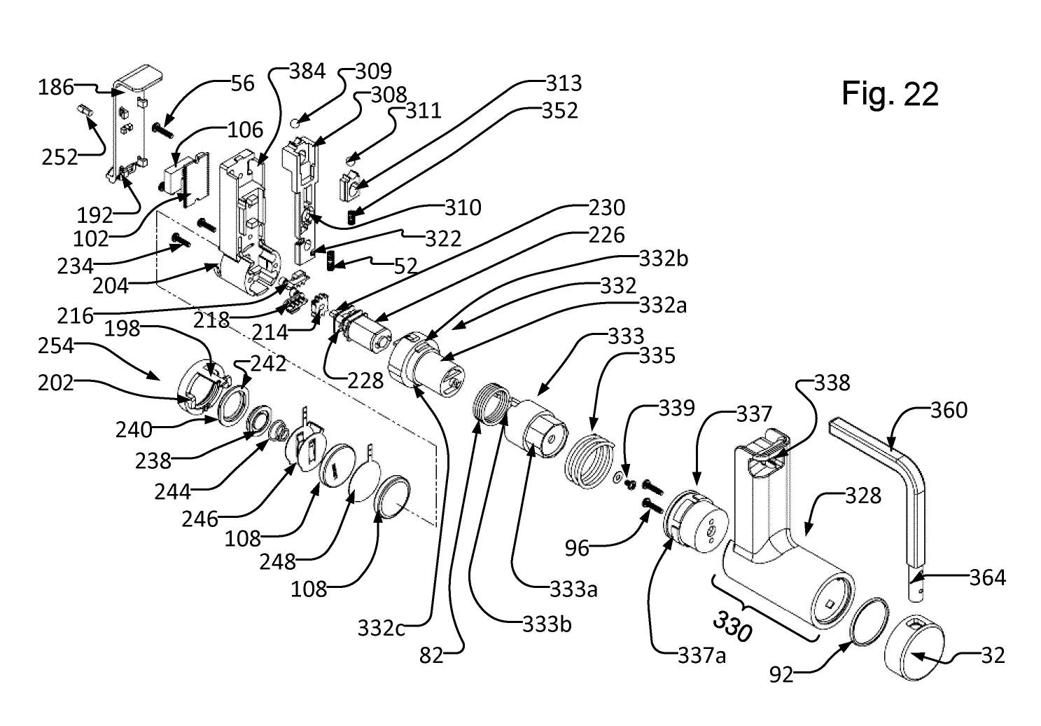

FIG. 22 is an exploded view of lock 300. Some elements which are the same as or similar to corresponding elements in other embodiments are identified by the same reference numbers assigned above. These include shackle cap 32, pivot spring 82, tang bolt(s) 96, plate washer 92, striker spring 52, locking carrier cover 186, motor 226 with reduction gear 228, output shaft 230, pinion 214, top rack 216, bottom rack 218, battery cover 194, external battery receiver 254, main circuit board 102 and drive circuit board 106.

One feature of lock 300 is that when the free end of shackle 360 is engaged with receiver 338, shackle 360 can also slide in a direction parallel to the axis of rotation between the first latched configuration and the second latched configuration. The space between housing 328 and shackle 360 is smaller in the first latched configuration than in the second latched configuration. Lock 300 may be locked when shackle 360 is in the second locked configuration.

In lock 360, shackle 360 is mounted to hinge 337 by way of shackle cap 32. Hinge 337 is slidably disposed within hinge cover 330. When shackle 360 is in the first latched configuration (FIG. 19) shackle 360 is blocked from rotating because the tip of shackle 360 is blocked by a wall of receiver opening 338. In addition, as shackle 360 is moved into its first latched configuration, features on the outside of hinge 337 non-rotationally engage corresponding features on the inside wall of hinge cover 330. In the illustrated embodiment the features are splines 337a and 330a. However, the features may take other forms. For example, the features may comprise complementary non-circular cross-sectional shapes. The shapes may comprise splines, complementary polygonal shapes, or the like such that hinge 337 is non-rotationally engaged within hinge cover 330 when lock 300 is in its first latched configuration

Another feature of lock 300 is that it has a pair of latching mechanisms. One latching mechanism comprises striker plate 308 cooperating with ball 309. A second latching mechanism comprises secondary striker 313 and ball 311. Secondary striker 313 is biased toward receiver 338 by secondary striker spring 352. When shackle 360 is in the second latched position, ball 311 is engaged in divot 362a. When shackle 360 is slid into its first latched position, ball 309 is engaged in divot 362a and ball 311 is engaged in divot 362b. When lock 300 is locked, striker plate 308 holds ball 309 in engagement with divot 362A. When lock 300 is locked, the second latching mechanism helps to block any attempt by a person trying to force lock 300 from applying force to ball bearing 309.

When lock 300 is in the locked configuration shackle 360 is prevented from rotating by all of: the engagement of ball 309 in divot 362a, the engagement of features 337a on hinge 337 with corresponding features in hinge cover 330 and the engagement of the tip of shackle 360 within receiver 338. In addition, the engagement of ball 311 in divot 362b further resists attempts to rotate shackle 360 when lock 300 is locked.

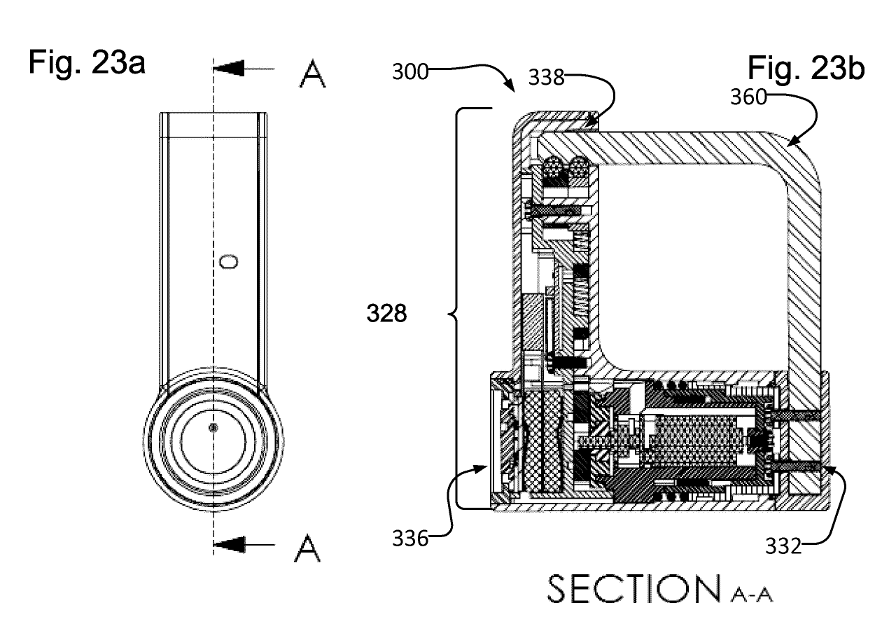

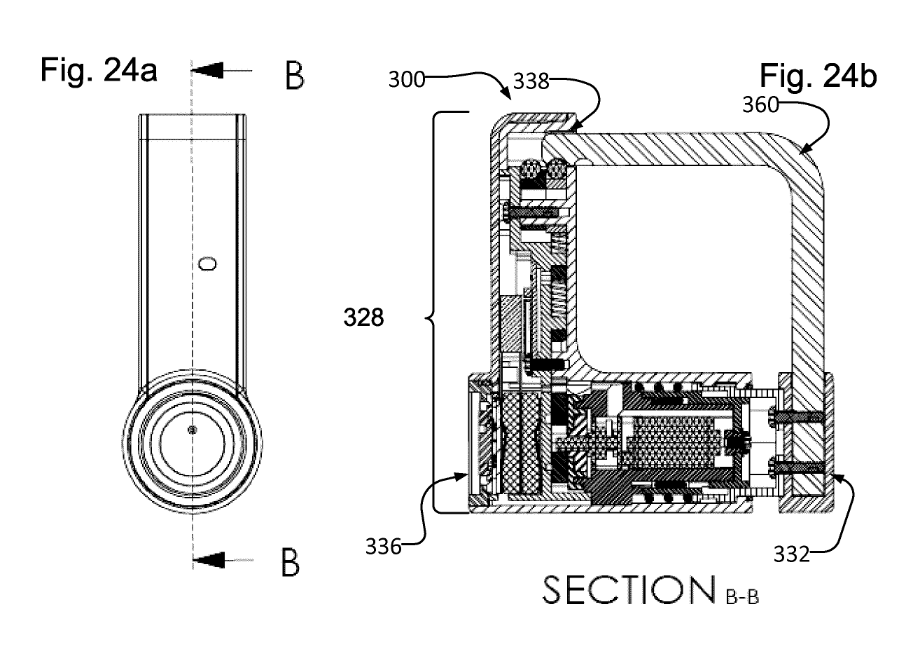

FIG. 23b is cross-section of lock 300 in plane A-A (see FIG. 23a) with lock 300 in its locked state. Shackle 360 is received in receiver 338. Striker plate 308 has been advanced toward receiver 338 such that ball 309 engages divot 362a in shackle 360. Ball 311 is engaged in divot 362b in shackle 360. Striker plate is held in its locked position by the engagement of rack stop(s) 322 with striker plate 308 as described above with reference to lock 180 (see FIGS. 10a, 10b and 10c and the associated text). FIG. 24b is cross-section of lock 300 in plane B-B (see FIG. 24a) with lock 300 in its second latched state. In this state, ball 311 engages divot 362a in shackle 360. A user may pivot shackle 360 from the second latched state to the open state.

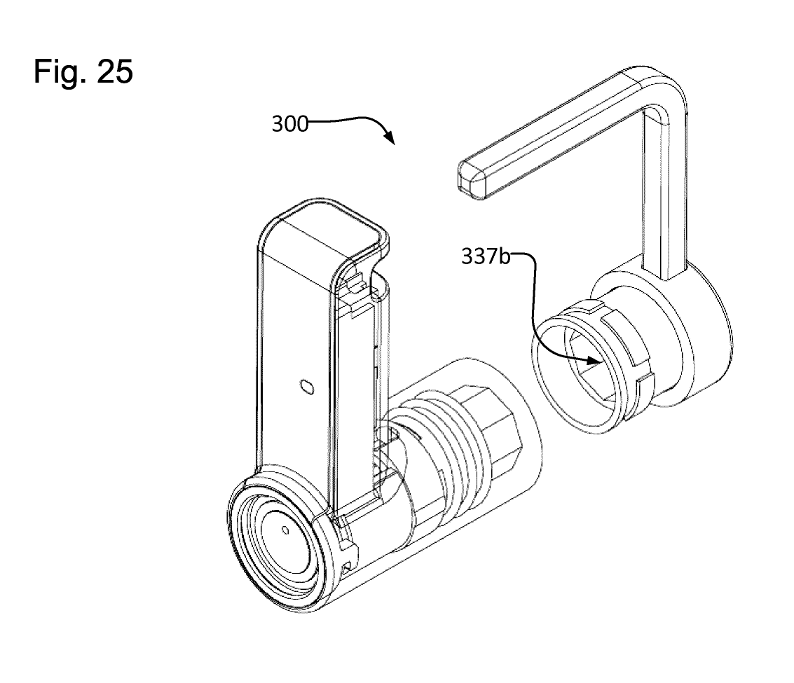

FIG. 25 is a partially exploded isometric view of lock 300. This view illustrates non-rotational engagement of spring cover 333 and hinge 337. In the illustrated embodiment, end portion 333a of spring cover 333 has the form of a hexagonal shaft which is slidably received in a corresponding hexagonal recess 337b in hinge 337. Hinge 337 is attached to the shackle tang 364 of the shackle 360 such that when hinge 337 slides along spring cover 333, shackle 360 is able to move between the first latched position and the second latched position. Compression spring 335 is arranged to bias hinge 337 in an outward direction from the housing 328. Spring 335 assists in moving shackle 360 from its first latched configuration to its second latched configuration when lock 300 is unlocked. Torsion spring is arranged to bias shackle 360 to rotate into engagement with receiver 338.

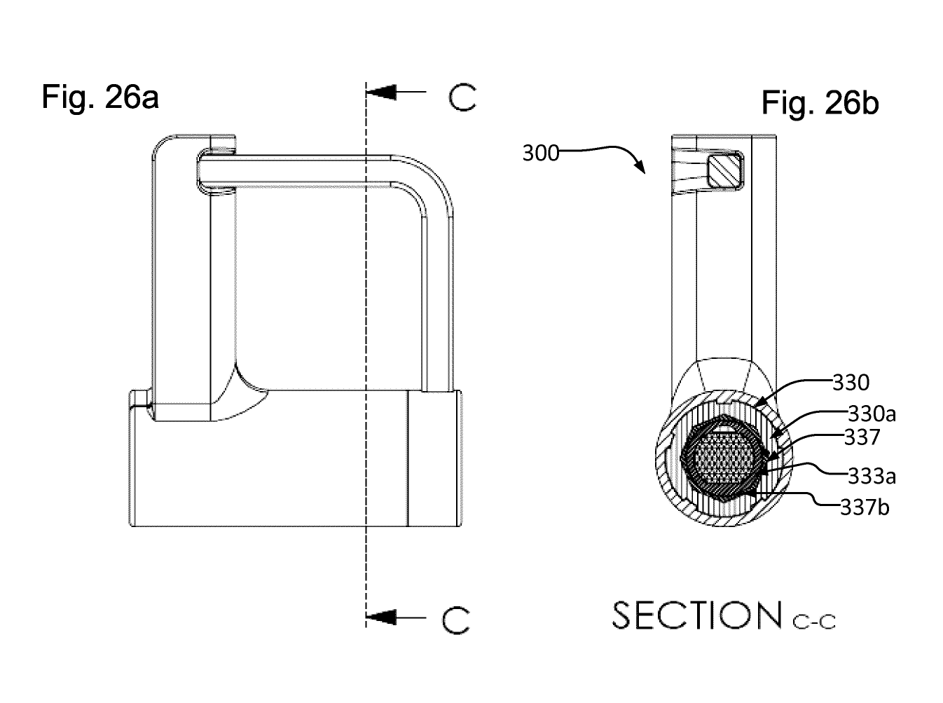

FIG. 26b is a transverse cross sectional view in a plane C-C (see FIG. 26a) with lock 300 in its locked configuration showing engagement of splines 330a on hinge cover 330 with splines 337a of hinge 337 when shackle 360 is in the first latched position. The engagement of splines 330a with 337a prevents rotation of hinge 337 and the attached shackle 360 thus providing additional security against prying. Splines 337a and splines 330a can take many forms as long as they allow hinge 337 to slide within hinge cover 330 and permit shackle 360 to rotate to its open position from the second latched position.

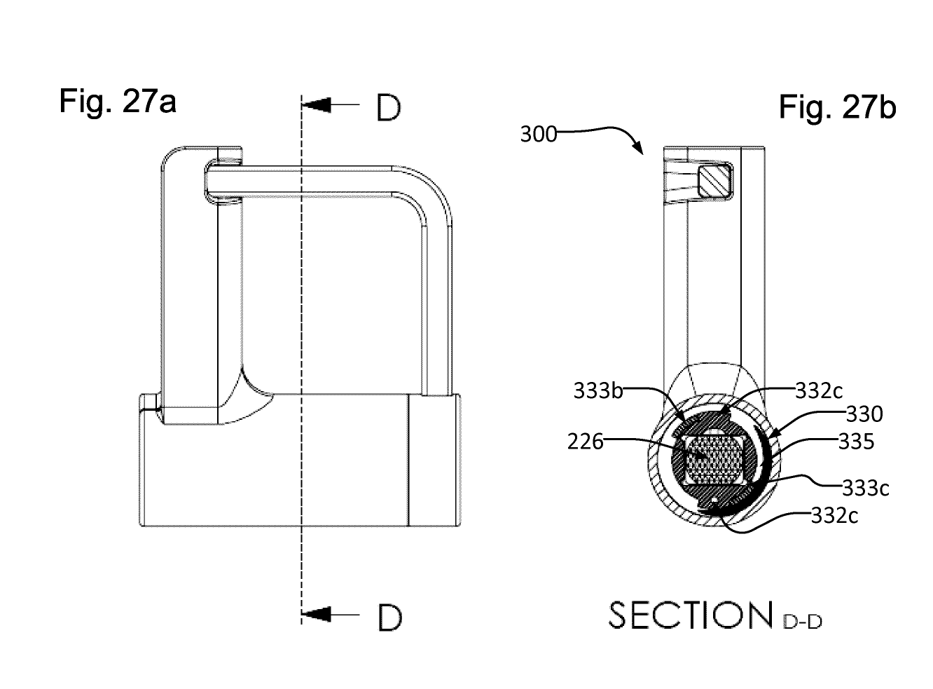

FIG. 27b is a transverse cross-sectional view of lock 300 in the plane D-D (see FIG. 27a). This view shows protrusions 332b and 332c of motor casing 332 contacting tabs 333b and 333c of spring cover 333. This contact occurs irrespective of whether the shackle 360 is in the first latched position or the second latched position. The contact between protrusions 332b and 332c and tabs 332b and 332c limits rotation of shackle 360. When shackle 360 is in a latched position, tab 333b contacts protrusion 332b and tab 333c contacts protrusion 333c limiting the rotation of the shackle 360 in the clockwise direction, as illustrated in FIG. 27b. When shackle 360 is in its maximally open position, tab 333b contacts protrusion 332c and tab 333c contacts protrusion 333b, preventing further rotation of shackle 360 in the counter-clockwise direction.

Lock 300 can be locked only when it is in the first configuration. In the first latched configuration, shackle 360 enters further into receiver 338 such that the housing itself prevents shackle 360 from rotating or being pried open. As with lock 180, lock 300 may have an actuating mechanism controlled by a wireless signal 16. When circuitry in lock 300 detects an authorized wireless signal, the circuitry may trigger operation of motor 226 to rotates pinion wheel 214 to cause top rack 216 and bottom rack 218 to move rack stops 222 inwardly to lock or outwardly to unlock lock 300. When lock 300 is not locked, balls 309 and 311 can be depressed, thereby allowing the user to manually move shackle 360 between the second latched position and first latched position against the force of compression spring 335 or from the second latched position to the open position against the force of pivot spring 82.

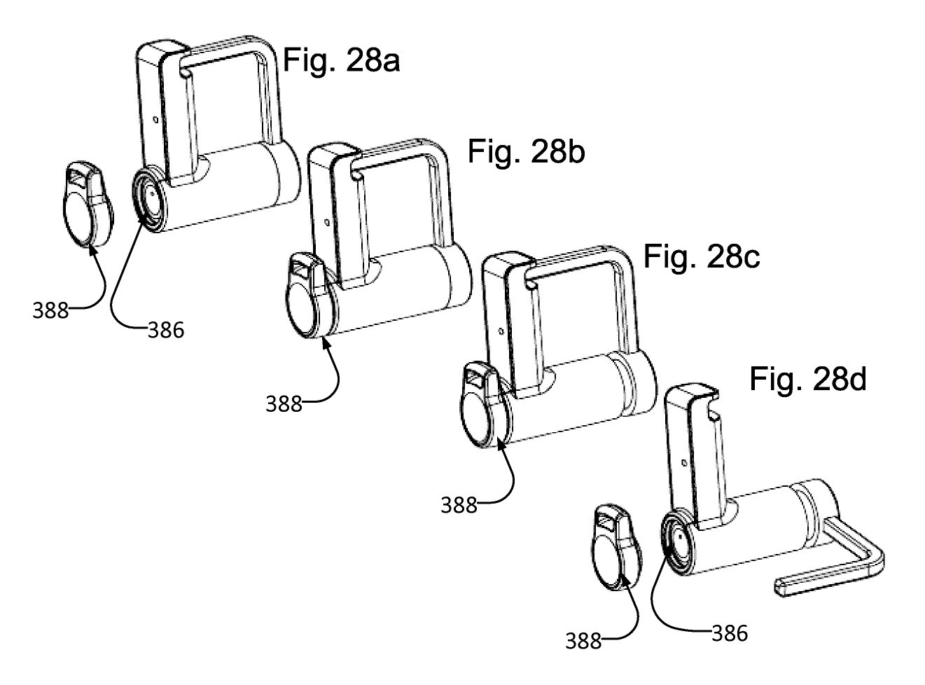

An authorized user may need to be able to open lock 300 even if the internal batteries die. FIGS. 28a to 28d depict another embodiment of lock 300 in which lock 300 has a receiver 386 which is accessible when lock 300 is locked. Receiver 386 is substantially similar to receiver 256 of pivot lock 180 and may receive a similar external battery to external battery 108. FIGS. 28a to 28d also depict a fob 388 that interfaces with receiver 386. Fob 388 may include a spare battery and means to open the lock 300. Further features of fob 388 are described in more detail below.

### Padlock

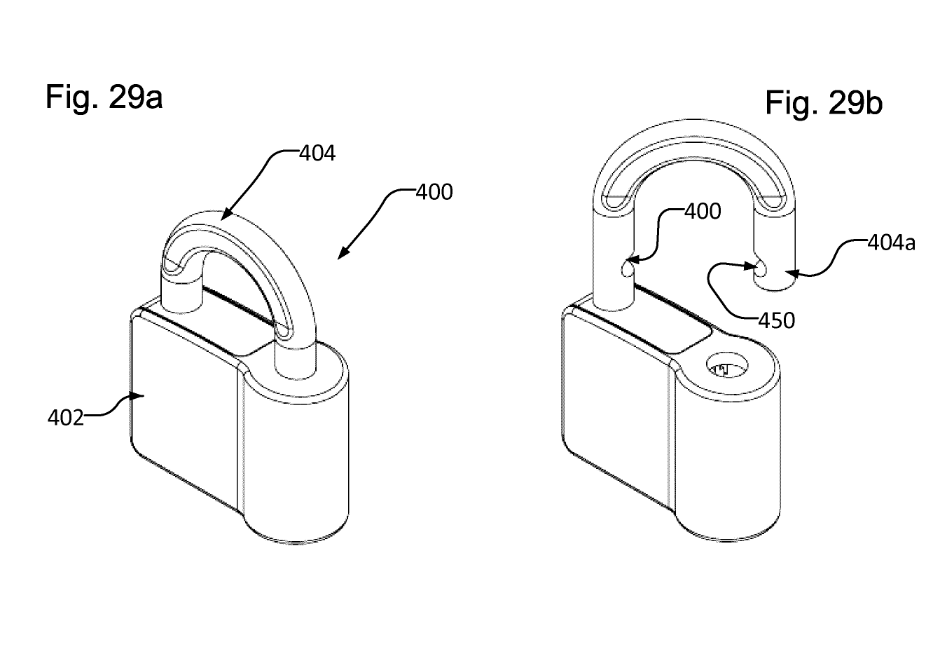

FIGS. 29a to 37c show an example padlock 400. As can be seen from FIGS. 29a and 29b, padlock 400 has an overall configuration similar to conventional key-operated padlocks. Padlock 400 has a shackle 404 that is slidably and pivotally mounted to a housing. Shackle 404 has a free end 404A that can be pivoted about a fixed end 404B. When shackle 404 is pivoted to line up with an aperture in the housing, the free end can slidably engage the housing to move between an unlocked position and a latched/locked position. In the unlocked position the free end of the shackle may be inserted through an aperture, such as a hasp, eye or the like, or may be passed behind an object, such as a part of an item to be secured by the lock. In the locked position the free end of the shackle is received by a receiver. When the lock is locked the free end is secured so that it cannot be removed from the receiver.

Padlock 400 comprises a housing 402 and a shackle 404. Housing 402 encloses and protects components of lock 400 other than shackle 404 such as the locking mechanism. The locking mechanism may be a motor actuated mechanism.

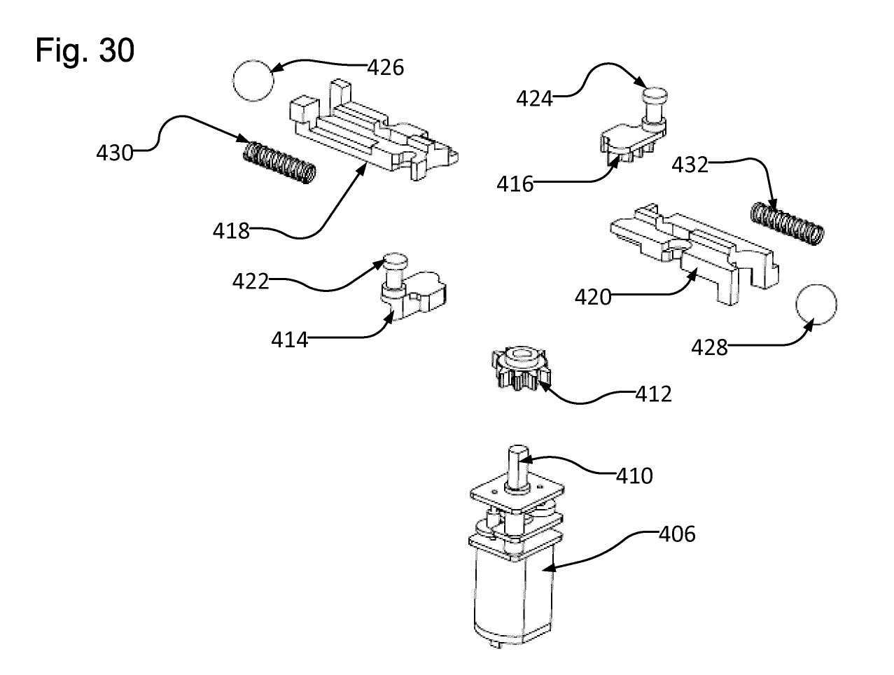

In one embodiment, the locking mechanism comprises a motor 406 which drives an output shaft 410 keyed to a pinion 412 by way of a reduction gear 408. Pinion 412 engages one or more racks. First rack 414 and second rack 416 are best shown in FIG. 30. First rack 414 has a first rack stop 422 and second rack 416 has a second rack stop 424. Rack stops 422 and 424 are both engageable with the first striker plate 418 and the second striker plate 420. First striker plate 418 and second striker plate 420 slidably engage and are biased apart by first striker plate spring 430 and second striker plate spring 432. First striker plate 418 engages first ball 426 and second striker plate 420 engages second ball 428. Balls 426 and 428 can engage fixed end indent 448 and free end indent 450 on inner sides of shackle 404 respectively.

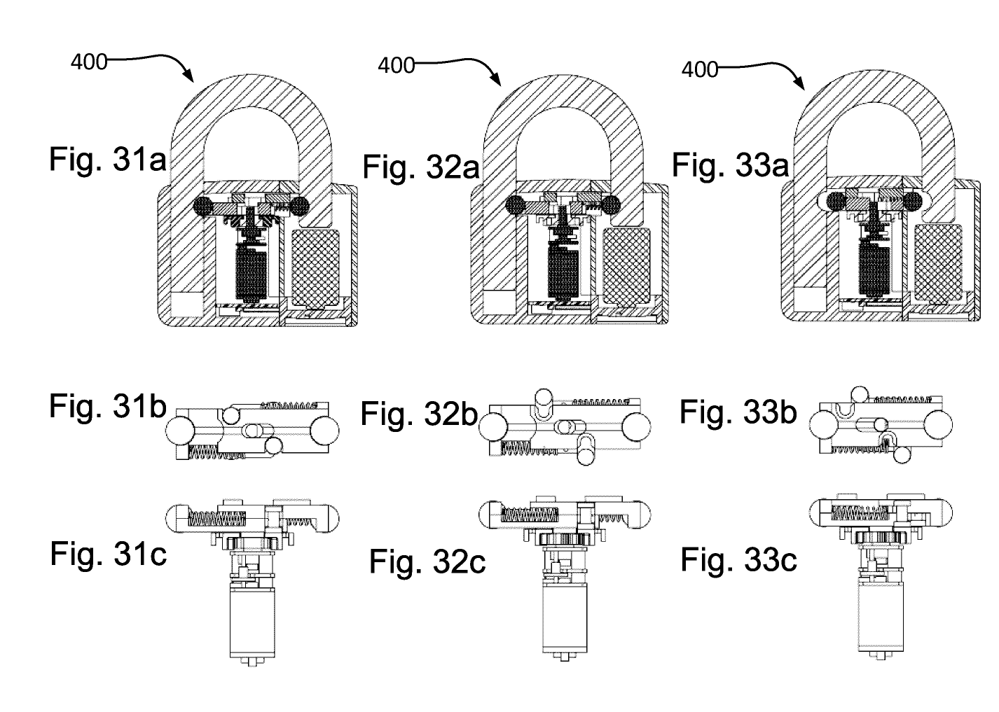

The state (locked-latched-unlocked) of padlock 400 is determined primarily by the position and freedom of movement of the first striker plate 418, the second striker plate 420, pinion 412, first rack 414, second rack 416, first rack stop 422, second rack stop 424, first ball 426, and second ball 428. FIGS. 31A to 31C show padlock 400 in the locked state. FIGS. 32A to 32C show padlock 400 in the latched state. FIGS. 33A to 33C show padlock 400 in the unlocked state.

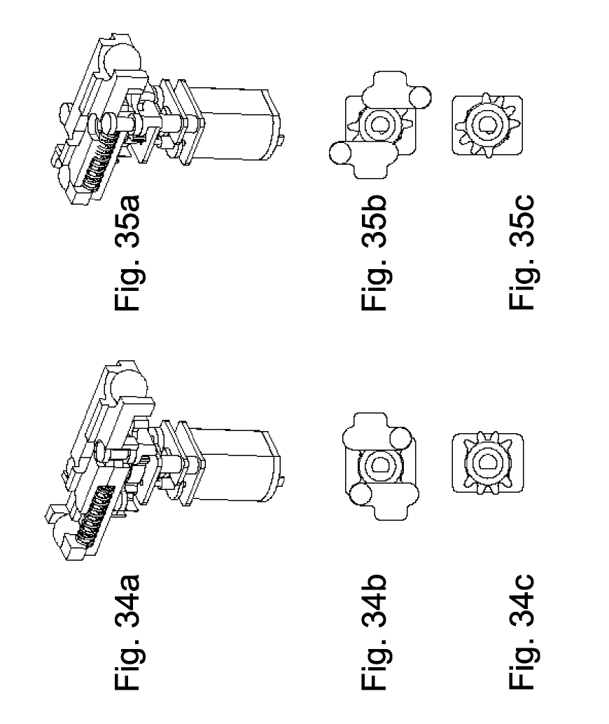

A wireless signal 16 triggers the actuator, which in this example embodiment comprises geared motor 406 which rotates pinion 412 wheel to slide first rack 414 and second rack 416 apart to latch, and together to lock the first striker plate 418 and the second striker plate 420. This is best illustrated in FIGS. 34A, 34B, 34C, 35A, 35B, and 35C. The padlock 400 in the latched state allows the first striker plate 418 and the second striker plate 420 to be pushed together, against the bias of first striker spring 430 and second striker spring 432, by force transferred through the first and second balls when a user pulls on the shackle 404. When the first and second striker plates are pushed together, first ball 426 and second ball 428 can disengage from fixed end indent 448 and free end indent 450 respectively, thereby allowing the user to manually slide the free end of the shackle out of the housing to open the lock as shown in FIG. 28B.

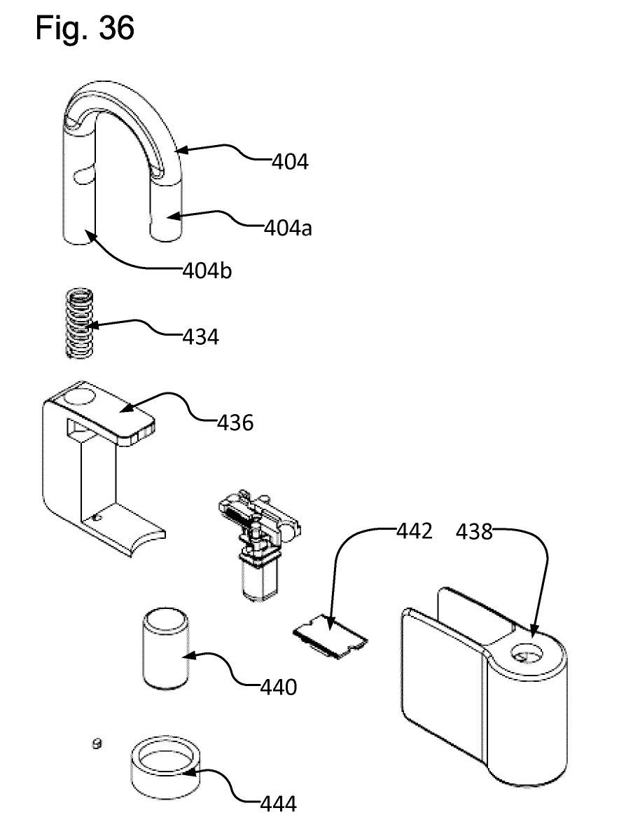

FIG. 36 is a partially-exploded view of one embodiment of padlock 400. In this embodiment, padlock 400 further comprises shackle spring 434 to bias the shackle into an open state and electronics 442 for receiving wireless signals and sending signals to the locking mechanism. Electronics 442 are powered by battery 440. Housing 402 comprises two parts, shackle housing 436 to which shackle 404 is attached and battery housing 438 in which battery 440 is contained. Battery 440 is secured within battery housing 438 by battery cover 444. Battery cover 444 may be configured so as to be secured when the padlock 400 is in the locked state and to be removable when padlock 400 is in the unlocked state. This mechanism may be similar to other covers described throughout this specification.

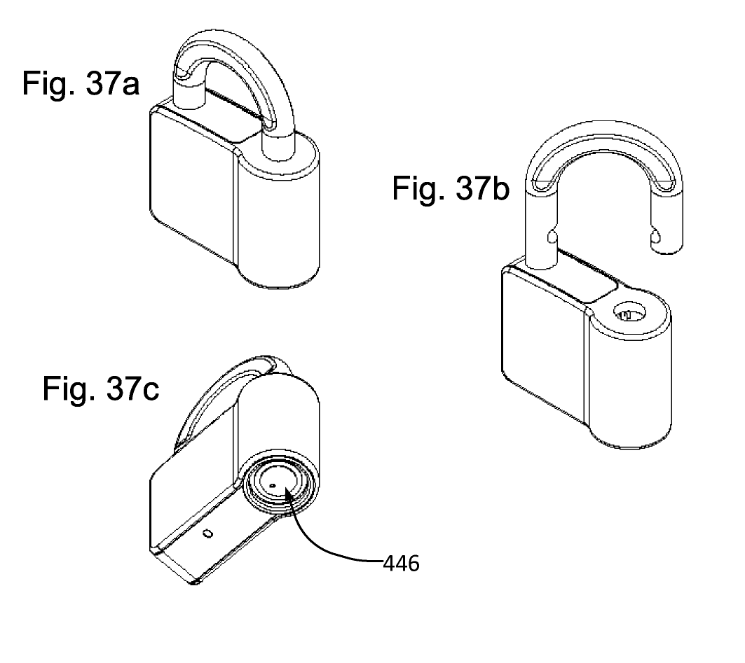

An authorized user may need to be able to open padlock 400 even if the internal batteries die. FIGS. 37A, 37B, and 37C depict another embodiment of padlock 400 in which padlock 400 has a receiver 446 which is accessible when padlock 400 is locked. Receiver 446 is substantially similar to receiver 256 of pivot lock 180 and may receive a similar external battery to external battery 108 or fob 388.

### Materials

A wide range of materials may be used for constructing locks as described herein. For example, housings and covers may be made of cast, forged, stamped or machined steel, brass. Exposed structures such as shackles, gates, hooks and/or structures that may experience significant wear such as gate wheels, pawls, catches and striker plates may be hardened, made from hardened steel, plated or otherwise coated with hard materials or have wear surfaces reinforced appropriately. Carriers may be made, for example of suitable plastics such as Delrin™ (acetal) or other suitable rigid materials. Carriers are advantageously made of electrically non-conductive materials. In addition or in the alternative, Kapton™ tape or similar electrical insulating material may be used to insulate between components and to prevent unwanted conduction paths as needed. Pulleys, plates & washers that are desired to be electrically insulating may be made, for example, from acetal (e.g. Delrin™), ceramic or nylon as desired to provide adequate electrical isolation. Other materials may be used also or in the alternative.

### Additional Options

Any lock as described herein (e.g. a lock 26, 110, 180, 300, or 400) may also include a portable key fob that interfaces with the lock. The fob device may act as a key to open the lock in the absence of a wireless signal and/or supply power to operate the lock. Such a fob may, for example, fit into an external battery receiver 254, 386, or 446). Where the fob device holds a spare battery, the spare battery may supply external power through the battery receiver. The portable fob may also comprise means to open the pivot lock 180 such as a readable memory chip or a wireless module that can be interrogated by the lock or transmit a passcode to the lock or a wired path between the fob and a Bluetooth™ receiver in the lock. Such a fob may be used as a convenient portable backup means to open a specific lock or multiple locks.

In another embodiment a fob and lock may be configured such that a particular fob can only be used a defined number of times (e.g. once, ten times, seven times, one hundred times) and/or during a limited period (which may be defined from the first time the fob is used—e.g. for 24 hours after the fob is first used, for one week after the fob is first used—or which may be defined in terms of times/dates—e.g. between 10:00 a.m. and 5:00 p.m. on a specified day or days). A fob as described herein may employ a rolling passcode that needs to be reset by a parent device (e.g. a smartphone originally paired with the lock). such a fob may be used in order to allow access to the lock under defined conditions but to prevent unauthorized access.

In addition, a wirelessly accessible portable lock system as described herein may allow one to electronically re-key a lock or locks remotely and/or designate access limits by time and/or number of uses. For example, a signal receiver or other electronic system within the lock may include a counter that counts a number of times a particular passcode or other electronic key has been used to open the lock. The lock may also comprise a data store or fixed record containing a maximum number of times that the particular electronic key may be used to open the lock. The lock may include logic circuits configured to compare the value stored by the counter to the maximum number of times that the particular electronic key may be used to open the lock and to inhibit operation of the lock by the particular electronic key if doing so would cause the value of the counter to exceed the maximum number.

The shapes of gates and shackles may be varied for specific applications. For example, a pivot lock shackle need not be L-shaped but may have other shapes that permit a free end of the shackle to engage a receiver. Other shapes can be employed for specific applications such as special reinforced conduits covering the shackle, as may be employed on shipping containers or security doors or portable equipment containers.

### Advantages of Some Example Embodiments

Various embodiments described herein have certain advantages over conventional padlocks. Not all embodiments necessarily provide any or all of these advantages.

An advantage to using an L-shaped shackle as compared to the common U-shaped shackle is that most loops or door hasps through which padlock shackles are inserted are vertical, requiring a user to rotate a conventional padlock lock hook the U-shaped shackle through the hasp or loop. By contrast, an L-shaped shackle may be easily inserted directly and, in the case of a self-closing lock may then snap shut automatically and reliably.

Embodiments which provide a self-closing clip or shackle may advantageously facilitate one-handed operation.

Embodiments which are controlled using a portable device such as a smartphone have the advantage that separate keys are not required. Also there is no need to orient a lock and fit a key into a keyway in cases where the lock is controlled by wireless signals. Further, a wirelessly-controlled lock does not require a keyway. A keyless portable lock can be made resistant to water and other contaminants Users with hand/finger disabilities or similar impairments will find that a lock system which can be remotely unlocked without the need for keyed operation, and which requires less strenuous pivoting or levering will be much easier to open than conventional padlocks.

Wireless lock actuation may permit faster lock securement and/or removal of one or many locks. Devices can be conveniently opened as a user approaches, by the user, anyone sent the passcode, or even by a facility security administrator from a distance. The ability to electronically transfer a passcode to an authorized user's wireless device 12 as they stand in front of a wireless lock barring their way is an advantage that mechanical locks and physical keys lack. An additional level of security can be created by using rolling pass-codes, and limiting the number of unsuccessful unlocking attempts, neither of which could be possible with generic mechanical locks.

The foregoing description of the preferred apparatus and method of fabrication and operation should be considered as illustrative only, and not limiting. Other forming techniques and other materials may be employed towards similar ends. Various changes and modifications will occur to those skilled in the art, without departing from the true scope of the invention as defined in the above disclosure, and the following illustrations.

### Interpretation of Terms

Unless the context clearly requires otherwise, throughout the description and the
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”)). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a lock may implement methods as described herein (e.g. methods of receiving a signal, determining that the signal authorizes opening or locking a lock and controlling an actuating mechanism to open or lock the lock by executing software instructions in a program memory accessible to the processor(s).

Software and other modules may reside on servers, workstations, personal computers, tablet computers, smart phones, PDAs, and other devices suitable for the purposes described herein. Those skilled in the relevant art will appreciate that aspects of the system can be practised with other communications, data processing, or computer system configurations, including: Internet appliances, hand-held devices (including personal digital assistants (PDAs)), wearable computers, all manner of cellular or mobile phones, multi-processor systems, microprocessor-based or programmable consumer electronics and the like.

In some embodiments, aspects of the invention or components of embodiments of the invention may be implemented in software. For greater clarity, “software” includes any instructions executed on a processor, and may include (but is not limited to) firmware, resident software, microcode, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Where a component (e.g. an arm, member, mechanism, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting features, elements and/or acts from described embodiments.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A portable lock comprising:
a lock body;
a locking arm having a first end pivotally connected to the lock body for pivotal rotation about the first axis and a free end movable relative to the lock body, the locking arm pivotally movable between a closed position wherein the free end engages a portion of the lock body and an open position wherein the free end is spaced apart from the portion of the lock body by a gap, the locking arm constrained to move relative to the lock body only by rotation about the first axis; and
an electrically-controlled locking mechanism having: a locked configuration wherein, with the locking arm in the closed position, the locking mechanism locks the locking arm in the closed position; and an unlocked configuration wherein the locking arm is pivotally movable from the closed position to the open position;
a signal receiver connected to control the locking mechanism to switch from the locked configuration to the unlocked configuration in response to receiving an unlock signal.

2. A portable lock according to claim 1, comprising a bias mechanism arranged to bias the locking arm toward the closed position.

3. A portable lock according to claim 1, wherein the portable lock is configured with an access limit that limits a number of times the unlock signal may be used to activate the locking mechanism.

4-5. (canceled)

6. A portable lock according to claim 2, wherein the locking arm and lock body lie in a common plane when the locking arm is in the closed position and wherein the locking arm leaves the plane when it pivots into the open position.

7. A portable lock according to claim 6, further comprising:
a striker plate within the lock body movable between an unlatched position and a latched position and biased toward the latched position, the striker plate configured, when in the latched position, to block the locking arm from being moved from the closed position to the open position;
an electromechanical driver; and
a locking block coupled to the electromechanical driver; wherein
the electromechanical driver is operable in response to an electrical signal from the signal receiver to move the locking block into contact with the striker plate to secure the striker plate in the latched position.

8. A portable lock according to claim 7, wherein the free end of the locking arm is notched and the striker plate comprises a protrusion that engages the notch in the locking arm when the striker plate is in the latched position thereby securing the locking arm in the closed position.

9. A portable lock according to claim 7, the locking block comprising a first bar and a second bar, each having a protrusion, the first bar and the second bar movable by the electromechanical driver in parallel and opposite directions that are generally transverse to a direction in which the striker plate is movable; wherein
the protrusion on the first bar is engageable with a corresponding first indent on the striker plate;
the protrusion on the second bar is engageable with a corresponding second indent on the striker plate; and
when the first bar and the second bar are moved to bring the protrusions toward one another, the protrusion on the first bar and the protrusion on the second bar protrude into the first indent and the second indent respectively, thereby securing the striker plate in place.

10. A portable lock according to claim 9, wherein the first bar comprises a first rack, the second bar comprises a second rack and the first and second racks are drivingly engaged with a pinion driven by the electromechanical driver, wherein when the pinion is driven, the first bar and the second bar are simultaneously moved in parallel and opposite directions generally transverse to the direction in which the striker plate is movable.

11. (canceled)

12. A portable lock according to claim 1, wherein the locking arm and lock body lie in a common plane when the locking arm is in the closed position and wherein the locking arm and the body remain in the common plane as the locking arm moves from the closed position into the open position.

13. A portable lock according to claim 12 comprising:
a gate wheel fixed to pivot with the locking arm, the gate wheel having a gate wheel notch;
a pawl pivotally movable between an engaged position wherein the pawl is positioned to be received in the gate wheel notch and a disengaged position, the pawl biased toward the engaged position; and
a pawl wire coupled to the pawl;
wherein the electrically-controlled locking mechanism is coupled to the pawl by the pawl wire.

14. A portable lock according to claim 13, comprising a catch biased into contact with the pawl, the catch located to stop the pawl from moving into the engaged position; the catch movable by applying tension to a catch wire into a position such that the catch does not block the pawl from moving into its engaged position.

15. A portable lock according to claim 14, wherein the pawl wire and the catch wire are made of memory wire of a type that contracts when energized.

16. A portable lock according to claim 15, wherein:
a first end of the pawl wire is anchored to the lock body and a second end of the pawl wire is coupled to the pawl such that when the pawl wire is energized and contracts, the wire pulls the pawl to pivot into the disengaged position;
a first end of the catch wire is anchored to the lock body and a second end of the catch wire is coupled to the catch such that when the catch wire is energized and contracts, the catch wire pulls the catch out of contact with the pawl;
if the catch wire is energized and the pawl wire is de-energized, the pawl is free to move into the engaged position to secure the locking arm in the closed position; and
if the pawl wire is energized and the catch wire is de-energized, the pawl is secured in the disengaged position by the catch, allowing the locking arm to pivot freely.

17-20. (canceled)

21. A portable lock according to claim 1, the portable lock further comprising at least one releasably securable cover that, when opened, provides access to an interior of the lock, wherein the cover comprises a projecting element that is engaged by the locking mechanism when the locking mechanism is in its locked configuration such that the cover cannot be opened when the locking mechanism is in its locked configuration.

22. A portable lock according to claim 21, wherein the projecting element comprises a locking tab engageable by a striker plate of the locking mechanism.

23. (canceled)

24. A portable lock comprising:
a lock body;
a hinge slidably and pivotally attached within an end of the lock body for pivotal rotation about a first axis and slidable movement along the first axis;
a locking arm extending from the hinge and having a free end movable relative to the lock body, the locking arm slidably movable between a first latched position and a second latched position and pivotally movable between the second latched position and an open position;
an electrically-controlled locking mechanism having: a locked configuration wherein, with the locking arm in the first latched position, the locking mechanism locks the locking arm in the first latched position; and an unlocked configuration wherein the locking arm is slidably movable between the first latched position and the second latched position and pivotally movable between the second latched position and the open position.

25. A portable lock according to claim 24, further comprising:
a signal receiver connected to control the locking mechanism to switch from the locked configuration to the unlocked configuration in response to receiving an unlock signal.

26. A portable lock according to claim 24, further comprising:
a striker plate within the lock body movable between an unlatched position and a latched position, the striker plate in contact with a first ball configured, when in the latched position, to block the locking arm from being moved from the first latched position to the second latched position;
an electromechanical driver; and
a locking block coupled to the electromechanical driver; wherein
the electromechanical driver is operable in response to an electrical signal from the signal receiver to move the locking block into contact with the striker plate to secure the striker plate in the latched position.

27. A portable lock according to claim 26, further comprising:
a detent mechanism, the detent mechanism comprising a second ball within the lock body movable between an unlatched position and a latched position and biased towards the latched position; wherein
in the latched position, the second ball is releasably engageable with the locking arm when the locking arm is in the second latched position and is engageable with the locking arm when the locking arm is in the first latched position to prevent access to the first ball.

28. A portable lock according to claim 24, the hinge further comprising splines arranged to non-rotationally engage the lock body when the locking arm is in the first latched position and disengage the lock body when the locking arm is moved into the second latched position.

29. A portable lock according to claim 26, the locking block comprising a first bar and a second bar, each having a protrusion, the first bar and the second bar movable by the electromechanical driver in parallel and opposite directions that are generally transverse to a direction in which the striker plate is movable; wherein
the protrusion on the first bar is engageable with a corresponding first indent on the striker plate;
the protrusion on the second bar is engageable with a corresponding second indent on the striker plate; and
when the first bar and the second bar are moved to bring the protrusions toward one another, the protrusion on the first bar and the protrusion on the second bar protrude into the first indent and the second indent respectively, thereby securing the striker plate in place.

30. A portable lock according to claim 29, wherein the first bar comprises a first rack, the second bar comprises a second rack and the first and second racks are drivingly engaged with a pinion driven by the electromechanical driver, wherein when the pinion is driven, the first bar and the second bar are simultaneously moved in parallel and opposite directions generally transverse to the direction in which the striker plate is movable.

31-33. (canceled)

34. A portable lock according to claim 25, wherein the portable lock is configured with an access limit that limits a number of times the unlock signal may be used to activate the locking mechanism.

35-36. (canceled)

37. A portable lock according to claim 24, the portable lock further comprising at least one releasably securable cover that, when opened, provides access to an interior of the lock, wherein the cover comprises a projecting element that is engaged by the locking mechanism when the locking mechanism is in its locked configuration such that the cover cannot be opened when the locking mechanism is in its locked configuration.

38-44. (canceled)
